(19) United States
(12) Patent Application Publication
(10) Pub. No.: US 2022/0049054 A1
(43) Pub. Date: Feb. 17, 2022

(54) ALIPHATIC AND SEMI-AROMATIC POLYAMIDES WITH DIMER ACIDS AND DIMER AMINES

(71) Applicant: Ascend Performance Materials Operations LLC, Houston, TX (US)

(72) Inventors: Jacob G. RAY, Pace, FL (US); Bradley J. Sparks, Pace, FL (US); Ramesh Ramakrishnan, Houston, TX (US); Nanayakkara L. Somasiri, Pensacola, FL (US)

(73) Assignee: Ascend Performance Materials Operations LLC, Houston, TX (US)

(21) Appl. No.: 17/401,785

(22) Filed: Aug. 13, 2021

Related U.S. Application Data
(60) Provisional application No. 63/065,281, filed on Aug. 13, 2020.

(51) Int. Cl. C08G 69/28; C08G 69/26; C08K 13/02

(52) U.S. Cl. CPC C08G 69/28; C08K 5/17; C08K 13/02; C08G 69/265

(57) ABSTRACT

A polyamide composition comprising from 45 wt % to 95 wt % of polyamide polymer and from 5 wt % to 55 wt % of a modifier comprising a C₁₈₋₄₄ dimer acid or a C₁₈₋₄₄ dimer amine or a combination thereof. A number average molecular weight of the polyamide polymer is less than 30,000 g/mol. The polyamide composition has a chemical resistance, as measured by exposure to HCl (10%) for 14 days at 58° C., resulting in a weight loss of less than 3.0 wt %; and a moisture uptake of less than about 2.0 wt % moisture at 95% RH. A process for preparing the polyamide composition is also disclosed.

### CROSS REFERENCE TO RELATED APPLICATIONS

This application claims priority to U.S. Provisional Application No. 63/065,281, filed Aug. 13, 2020, which is incorporated herein by reference.

### FIELD

The present disclosure relates generally to polyamide compositions having improved chemical resistance and reduced moisture uptake, while maintaining mechanical properties and temperature resistance.

### BACKGROUND

Many varieties of natural and artificial polyamides have found use in various applications due to their high durability and strength. Some polyamide compositions can be formulated to have high melting points, high recrystallization temperatures, fast injection molding cycle times, high flow, toughness, elasticity, chemical resistance, inherent flame retardancy, and/or abrasion resistance. These desirable chemical and mechanical properties can make polyamide compositions suitable for use in constructing such diverse products as tubing, cable ties, sports equipment and sportswear, gun stocks, window thermal breaks, aerosol valves, automotive/vehicle parts, textiles, industrial fibers, carpeting, and electrical/electronic parts.

As one example, in the automotive industry there is an environmental need to reduce emissions and to increase the efficiency of fuel consumption. One approach towards achieving these goals is to reduce overall vehicle weight by substituting metal components with thermoplastic ones. And often times, polyamide compositions have been employed to provide such weight reduction in the engine compartment. Some of these polyamide compositions have also been found to be particularly well suited for automotive use due to their aforementioned heat resistance, mechanical strength, and overall appearance. Exemplary applications can include tubing or jacketing for oil and gas or chemical applications, aerospace applications, wire and cable applications, back panels for the solar industry, various consumer applications, and automotive applications. Applications also include powder coatings for dishwasher racks and shopping carts, flexible tubing or hoses for oil and gas applications, electrical connectors, and solar backpanel sheers, among others, which required excellent hydrolysis resistance. Applications, e.g., radiator end tanks or underbody parts, may also require chemical resistance, such as CaCl₂ resistance.

U.S. Patent Application Publication No. US 2019/0194392 discloses a polymer film comprising at least one copolyamide. The copolyamide is prepared by polymerizing a first monomer mixture (M1), containing at least one C₄-C₁₂ dicarboxylic acid and at least one C₄-C₁₂ diamine, and a second monomer mixture (M2) containing at least one C₃₂-C₄₀ dimer acid and at least one C₄-C₁₂ diamine. The application further relates to a process for producing the polymer film and to copolyamides for use as polymer film for high-temperature applications, such as packaging film, that demonstrate high tear propagation resistance. The copolyamides are prepared by polymerizing two separate monomer mixtures, where the resultant film has a melting temperature in the range from 220° C. to 290° C.

Conventional polyamide compositions for films (see above) naturally lack the characteristics for non-film applications, which generally require a high degree of chemical resistance and reduced moisture uptake, e.g., minimization of dimensional changes, as well as mechanical strength. Thus, even in view of the existing art, the need remains for improved polyamide compositions that effectively deliver both mechanical strength and temperature resistance as well as chemical resistance and reduced moisture uptake suitable for non-film applications.

### SUMMARY

In one embodiment, the disclosure is to a polyamide composition including from 45 wt % to 95 wt % of polyamide polymer and from 5 wt % to 55 wt % of a modifier. The modifier includes a dimer acid or a dimer amine or a combination thereof. The polyamide composition may demonstrate a chemical resistance, as measured by exposure to HCl (10%) for 14 days at 58° C., resulting in a weight loss of less than 3.0 wt % and/or a moisture uptake of less than about 2.0 wt % moisture at 95% RH. In certain embodiments, the polyamide composition has a methyl/amide ratio ranging from 6:1 to 15:1. In certain embodiments, the polyamide composition has a methyl/amide ratio ranging from 9:1 to 15:1. In certain embodiments, the polyamide composition includes from 20 wt % to 45 wt % of the modifier including a dimer acid or a dimer amine or a combination thereof. In some cases, the polyamide composition may demonstrate a moisture uptake of less than about 1.6 wt % moisture at 95% RH. In certain embodiments, the polyamide polymer includes PA10, PA11, PA12, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, PA6,C/6,18, or combinations thereof. In certain embodiments, the polyamide polymer includes PA6,6. In certain embodiments, the polyamide polymer includes PA6,10. In certain embodiments, the polyamide polymer includes PA6,12. In certain embodiments, the polyamide polymer includes PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, or combinations thereof. In certain embodiments, the number average molecular weight of the polyamide polymer ranges from 9,000 g/mol to 60,000 g/mol. In certain embodiments, the number average molecular weight of the polyamide polymer ranges from 20,000 g/mol to 45,000 g/mol. In certain embodiments, the number average molecular weight of the polyamide polymer ranges from 12,000 g/mol to 20,000 g/mol. In certain embodiments, the polyamide polymer has an amine end group content ranging from 10 microeq/g to 110 microeq/g. In certain embodiments, the polyamide polymer has an amine end group content ranging from 35 microeq/g to 80 microeq/g. In certain embodiments, the polyamide composition further includes up to 60 wt % glass fibers. In certain embodiments, the polyamide composition further includes up to 2 wt % lubricant. In certain embodiments, the polyamide composition further includes an additive chosen from a nigrosine dye, a copper containing compound, a plasticizer, or a flame retardant, or combinations thereof. In certain embodiments, the polyamide composition further includes up to 30 wt % mineral additive chosen from calcium carbonate, talc, magnesium hydroxide, kaolin clay, or combinations thereof. In certain embodiments, the polyamide composition further includes an impact modifier chosen from a modified olefin, an unmodified olefin, maleic anhydride-modified olefin, maleic anhydride-unmodified olefin, acrylate, or acrylic, or combinations thereof. In some embodiments, the polyamide polymer includes PA6,12, the dimer modifier is dimer amine present in an amount ranging from 15 wt % to 50 wt %, and wherein the polyamide composition demonstrates a tensile elongation of at least 50%. In some embodiments, the polyamide composition includes the polyamide polymer PA6,12 and the dimer modifier is dimer acid present in an amount ranging from 15 wt % to 50 wt %, and wherein the polyamide composition demonstrates a tensile elongation of at least 20%. In some embodiments, the polyamide composition includes the polyamide polymer PA6,12 and the dimer modifier is dimer amine present in an amount ranging from 35 wt % to 55 wt %, and wherein the polyamide composition demonstrates a notched Charpy impact energy loss at 23° C. that is greater than 4.5 kJ/m2. In some embodiments, polyamide composition includes the polyamide polymer PA6,12 and the dimer modifier is in an amount of about 20 wt %, and wherein the polyamide composition demonstrates a notched Charpy impact energy loss at 23° C. that is greater than 3.5 kJ/m2, a tensile strength greater than 50 MPa, and a tensile modulus greater than 1950 MPa. In certain embodiments, the polyamide polymer includes the polyamide composition demonstrates a tensile elongation greater than 30%. In certain embodiments, the polyamide composition demonstrates a notched Charpy impact energy loss at 23° C. that is greater than 3 kJ/m2. In certain embodiments, the polyamide composition demonstrates a tensile modulus greater than 650 MPa. In certain embodiments, the polyamide composition demonstrates a tensile elongation greater than 13%. In certain embodiments, the polyamide composition demonstrates an abrasion resistance greater than that of a reference PA6,12 material or a reference PA12 material.

In another embodiment, the disclosure is to an injection molded article. The article includes any of the provided polyamide compositions.

In yet another embodiment, the disclosure is to an article. The article includes any of the provided polyamide compositions. The article may be an extruded article, a profile extrusion article, a monofilament, or a fiber.

### BRIEF DESCRIPTION OF THE DRAWINGS

FIG. 1 illustrates a plot of storage modulus as a function of temperature for polyamides according to some embodiments herein as compared with homopolymers PA6,12 and PA12;

FIG. 2 illustrates a plot of glass transition, T_{g}, behavior shown as the peak in Tan Delta as a function of temperature for polyamides according to some embodiments herein as compared with homopolymers PA6,12 and PA12;

FIG. 3 illustrates a bar graph of the moisture uptake of polyamides according to some embodiments herein as compared with homopolymers PA6,12 and PA12; and

FIG. 4. illustrates a plot of the weight loss of polyamides according to some embodiments herein as compared with homopolymers PA6,12 and PA12.

### DETAILED DESCRIPTION

The present disclosure generally relates to polyamide compositions that, when employed for example in (non-film) extrusion and injection molded applications, provide advantageous improvements in both chemical resistance and reduced moisture uptake. For example, extruded or molded thermoplastic parts produced from the polyamide compositions have been found to demonstrate a high chemical resistance, allowing them to be used in diverse applications calling for lightweight constructions materials that can be substituted for metals. Such molded plastic parts demonstrate reduced moisture uptake to enable the material to minimize unwanted dimensional changes over time independent of climate. As described herein, the ability to tune modulus, via dimer content, to synergistically enable more flexible materials while having a high level of chemical resistance and low moisture uptake is unique. These advantages, in addition to lower manufacturing costs, have been achieved by the polyamide compositions described herein.

Typical polyamide resins and compositions have been unable to simultaneously meet these demands. One reason for this is that conventional modifications made to polyamide compositions with the goal of increasing chemical resistance or reducing moisture uptake are known in the art to adversely affect mechanical properties of the material. In some cases, typical polyamide preparations intended for construction applications included a filler such as glass fiber to supply additional reinforcement. The addition of glass fibers, however, has led to reduced mechanical properties, such as elongation and impact strength, which are desired for automotive and other applications.

As is well known in the art, polymer formulations for films are developed to be very different than those employed for non-film applications. As a few examples, film formulations desirably demonstrate lower crystallinity, lower crystallization rate, and higher molecular weights; to the latter point, film applications typically have number average molecular weights (Mₙ) values of greater than 25,000 g/mol or greater than 25,000 g/mol. In contrast, these characteristics are not desirable for non-film applications such as the compositions described herein because molded or extruded compounds typically have Mₙ values from 10,000 g/mol to 25,000 g/mol, especially for polyamides based on long chain polyamides such as (PA6,10, PA6,12, PA11, PA12, and others). For molded articles, tailoring higher levels of crystallinity and fast crystallization rate is desirable for fast cycle times. In addition, film formulations would not contemplate high levels of lubricants (e.g., greater than 1000 ppm), impact modifiers, plasticizers, colorants, glass, as are contemplated in some embodiments of the compositions described herein. And adding these components to film formulations would only add additional cost and complicate processing for little or no benefit.

Still further, film formulations are typically based on PA6-based formulations (or PA6,6), which inherently have high moisture uptake values. Thus, conventional PA6-based formulations do not require modifiers to provide good moisture uptake performance. Advantageously, the disclosed formulations and parts made from them are able to achieve excellent chemical and hydrolysis resistance without having PA-6 content.

As disclosed herein, the use of dimer acids and/or dimer amines in polyamide compositions, e.g., (long chain and/or high temperature) polyamide compositions, surprisingly provides for materials that demonstrate both increased chemical resistance and reduced moisture uptake, while still maintaining strength and high temperature performance. Moreover, in some aspects, the chemical resistance and/or moisture uptake properties can synergistically improve together with the overall mechanical performance. In particular, the inventors have found that certain types, amounts, and ratios of polyamide polymers, dimer modifiers, glass fiber, impact modifiers, melt stabilizers (lubricants), and optional heat stabilizers can be combined to produce the compositions having surprising chemical resistance and reduced moisture uptake while maintaining mechanical and impact properties. Without being bound by theory, it is believed that the dimer modifiers, e.g., dimer acids and dimer amines, work with the other components to synergistically meet application requirements related to modulus, temperature resistance, impact resistance, chemical resistance, and dimensional stability.

Generally, dimer acids or dimer amines have been known to have detrimental effects on tensile strength. However, when the disclosed modifiers are used together with the components of the aforementioned polyamide compositions, an unexpected balance is struck, and little or no loss in tensile performance is observed, while surprisingly chemical resistance and moisture uptake is significantly improved. In some cases, the disclosed formulations can contain a single dimer modifier or a combination of dimer modifiers to achieve the aforementioned performance benefits.

In contrast, conventional formulations, e.g., film formulations such as US 2019/0194392, require a different diamine in each of the at least two monomer mixtures and do not have chemical resistance and moisture uptake performance while maintaining strength characteristics. Again, these properties are not desirable for films, but are desirable for molded parts, e.g., automotive parts.

Notably, the importance of the component ratios (such as those disclosed herein) in simultaneously enabling advantageous chemical resistance and moisture uptake characteristics had not been previously appreciated. In addition, the inverse linear relationship of moisture uptake with methyl/amide ratio had not been previously appreciated. The methyl/amide ratio also proportionally increases relative to tensile elongation, abrasion resistance, and Charpy impact. Another advantage, especially for use in applications where lightweighting is desired, is the decrease in density with increasing methyl/amide ratios.

In one aspect, a polyamide composition is disclosed. The composition includes a polyamide polymer and a modifier, which may comprise a dimer acid or a dimer amine or a combination thereof. As described in greater detail below, in some cases, the composition preferably includes from 45 wt % to 95 wt % of the polyamide polymer and from 5 wt % to 55 wt % of the modifier. By employing these components in the polymer composition (optionally at the concentrations and ratios disclosed herein), a polyamide composition that demonstrates improved chemical resistance and moisture uptake characteristics is provided, for example, a polyamide composition demonstrating an improved chemical resistance to acids, bases, and various chemicals and/or a moisture uptake of less than about 2.0 wt % moisture at 95% relative humidity (RH). The polyamide compositions disclosed herein also demonstrate advantageous mechanical properties including a high tensile elongation, a high impact resistance as measured by notched Charpy impact energy loss at 23° C., a high tensile modulus, and a high abrasion resistance.

The components of the polyamide composition are now discussed individually. It is contemplated that these components may be employed with one another to form the aforementioned polyamide compositions.

### Polyamide Polymers

The polyamide of the disclosed compositions can vary widely and can include one polyamide polymer or two or more polyamide polymers. Exemplary polyamides and polyamide compositions are described in Kirk-Othmer, Encyclopedia of Chemical Technology, Vol. 18, pp. 328-371 (Wiley 1982), the disclosure of which is incorporated by reference. Briefly, polyamides are products that contain recurring amide groups as integral parts of the main polymer chains. Linear polyamides are of particular interest and may be formed from condensation of bifunctional monomers as is well known in the art. Polyamides are frequently referred to as nylons. Particular polyamide polymers and copolymers and their preparation are described in, for example, U.S. Pat. Nos. 2,071,250; 2,071,251; 2,130,523; 2,130,948; 2,241,322; 2,312,966; 2,512,606; 3,236,914; 3,472,916; 3,373,223; 3,393,210; 3,984,497; 3,546,319; 4,031,164; 4,320,213; 4,346,200; 4,713,415; 4,760,129; 4,981,906; 5,504,185; 5,543,495; 5,698,658; 6,011,134; 6,136,947; 6,169,162; 6,197,855; 7,138,482; 7,381,788; and 8,759,475, each of which is incorporated by reference in entirety for all purposes.

Polyamides of the present disclosure include aliphatic polyamides, semi-aromatic polyamides, polyphthalamides, and combinations thereof. The polyamide composition can include one or more polyamides such as PA10, PA11, PA12, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, or PA6,C/6,18, or combinations thereof. In some embodiments, the polyamides herein disclosed are devoid or substantially devoid of PA6 and/or PA6,6, e.g., contain less than 5 wt % PA-6, e.g., less than 3 wt %, less than 1 wt %, less than 0.5 wt %, less than 0.1 wt %, or no PA-6 at all.

In some cases, the one or more polyamide polymers of the composition include aliphatic systems, such as PA6,6, PA6,10, and PA6,12, which are known for strength and temperature resistance. The one or more polyamide polymers of the composition can include aliphatic polyamides such as polyhexamethylene adipamide (PA6,6), polyhexamethylene sebacamide (PA6,10), polyhexamethylene dodecanediamide (PA6,12), or other aliphatic nylons, polyamides with aromatic components such as paraphenylenediamine and terephthalic acid, and copolymers such as adipate with 2-methyl pentamethylene diamine and 3,5-diacarboxybenzenesulfonic acid or sulfoisophthalic acid in the form of its sodium sultanate salt. The polyamides can include polyaminoundecanoic acid and polymers of bis-paraaminocyclohexyl methane and undecanoic acid. Other polyamides include poly(aminododecanoamide), polyhexamethylene sebacamide, poly(p-xylyleneazeleamide), poly(m-xylylene adipamide), and polyamides from bis(p-aminocyclohexyl)methane and azelaic, sebacic and homologous aliphatic dicarboxylic acids. As used herein, the terms “PA6,12 polymer” and “PA6,12 polyamide polymer” also include copolymers in which PA6,12 is the major component. As used herein the terms “PA6,6 polymer” and “PA6,6 polyamide polymer” also include copolymers in which PA6,6 is the major component. In some embodiments, copolymers such as PA-6,6/6I; PA-6I/6T; or PA-6,6/6T, or combinations thereof are contemplated for use as the polyamide polymer. In some cases, physical blends, e.g., melt blends, of these polymers are contemplated. In one embodiment, the polyamide polymer comprises PA6,12, or PA12, or a combination thereof.

As noted above, long chain polyamides, generally, are contemplated. In some cases PA6,10, PA6,12, PA10, and/or PA12 demonstrate particularly synergistic results with the aforementioned dimer modifiers. Many film formulation references often disclose polyamides broadly, but do not focus on these long chain polyamides. Nor do conventional formulations contemplate the synergistic benefits demonstrated with long chain polyamides, as have been found and shown herein.

In some embodiments, the polyamide compositions include polyamides produced through the ring-opening polymerization or polycondensation, including the copolymerization and/or copolycondensation, of lactams. These polyamides can include, for example, those produced from propriolactam, butyrolactam, valerolactam, and caprolactam. For example, in some embodiments, the composition includes a polyamide polymer derived from the polymerization of caprolactam. In some embodiments, the polyamide compositions can include laurolactam, or PA12. In some cases, these lactam components may be considered optional.

In some cases, the disclosed compositions may expressly exclude one or more of the aforementioned additives in this section, e.g., via claim language. For example claim language may be modified to recite that the disclosed compositions, processes, etc., do not utilize or comprise one or more of the aforementioned lactams. This is applicable to the many additives and/or components disclosed herein.

The polyamide compositions, in some case, comprise semi-aromatic polyamides, which are known for high strength, high temperature resistance, as well as adequate resistance to long term heat exposure and dielectric strength. The polyamide compositions can include polyphthalamides, such as PA6T/66, PA6T/6I, and PA6T/DT. Polyphthalamides are defined as semi-aromatic polyamides in which the residues of terephthalic acid and/or isophthalic acid comprise at least 55 molar percent of the repeat units as classified by ASTM D5336. For example, the polyamide may comprise polyphthalamides chosen from PA-4T/41; PA-4T/6I; PA-5T/51; PA-6; PA-6,6; PA-6,6/6; PA-6,6/6T; PA-6T/6I; PA-6T/6I/6; PA-6T/6; PA-6T/6I/66; PA-6T/MPDMT (where MPDMT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/6I/6; PA-6T/6I/12; and combinations thereof.

The concentration of the one or more polyamide polymers in the overall polyamide composition can, for example, range from 45 wt % to 95 wt %, e.g., from 45 wt % to 55 w %, from 50 wt % to 60 wt %, from 55 wt % to 65 wt %, from 60 wt % to 70 wt %, from 65 wt % to 75 wt %, from 70 wt % to 80 wt %, from 75 wt % to 85 w %, from 80 wt % to 90 wt %, from 85 wt % to 95 wt %, or any subranges thereof. In some embodiments, the concentration of the one or more polyamide polymers ranges from 50 wt % to 85 wt %. In certain aspects, the concentration of the one or more polyamide polymers ranges from 45 wt % to 65 wt %. In terms of upper limits, the combined polyamide polymer concentration can be less than 95 wt %, e.g., less than 90 wt %, less than 85 wt %, less than 80 wt %, less than 75 wt %, less than 70 wt %, less than 65 wt %, less than 60 wt %, less than 55 wt %, or less than 50 wt %. In terms of lower limits, the combined polyamide polymer concentration can be greater than 45 wt %, e.g., greater than 50 wt %, greater than 55 wt %, greater than 60 wt %, greater than 65 wt %, greater than 70 wt %, greater than 75 wt %, greater than 80 wt %, greater than 85 wt %, or greater than 90 wt %. Lower concentrations, e.g., less than 45 wt %, and higher concentrations, e.g., greater than 95 wt %, are also contemplated. These ranges and limits may be applicable to individual polyamides as well.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

In some cases, the ranges and limits disclosed for the one or more polyamide polymers are applicable to PA6,6. In some cases, the ranges and limits disclosed for the one or more polyamide polymers are applicable to PA6,10. In some cases, the ranges and limits disclosed for the one or more polyamide polymers are applicable to PA6,12. In some cases, the ranges and limits disclosed for the one or more polyamide polymers are applicable to the PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, or PA6,T/6,18, or combinations thereof.

In certain aspects, the one or more polyamide polymers includes a PA6,6 polymer. PA6,6 has high strength and stiffness at high temperatures and good impact strength at even low temperatures, conveying significant advantages for use in a wide array of applications seeking a balance of properties including strength, temperature resistance, toughness, as well as chemical resistance. Further, the high crystallinity coupled with a fast crystallization rate of PA6,6 polymer make the polyamide polymers including PA6,6 desirable for injection molding processes. The concentration of the PA6,6 polymer in the one or more polyamide polymers can, for example, range from 0 wt % to 100 wt %, e.g., from 0 wt % to 60 wt %, from 10 wt % to 70 wt %, from 20 wt % to 80 wt %, from 30 wt % to 90 wt %, 25 wt % to 100 wt %, or from 40 wt % to 100 wt %. In terms of upper limits, the PA6,6 polymer concentration in the one or more polyamide polymers can be less than 100 wt %, e.g., less than 90 wt %, less than 80 wt %, less than 70 wt %, less than 60 wt %, less than 50 wt %, less than 40 wt %, less than 30 wt %, less than 20 wt %, or less than 10 wt %. In terms of lower limits, the PA6,6 polymer concentration in the one or more polyamide polymers can be greater than 0 wt %, e.g., greater than 10 wt %, greater than 20 wt %, greater than 30 wt %, greater than 40 wt %, greater than 50 wt %, greater than 60 wt %, greater than 70 wt %, greater than 80 wt %, or greater than 90 wt %. In some embodiments, the polyamides herein disclosed are devoid or substantially devoid of PA6,6, e.g., contain less than 5 wt % PA6,6, e.g., less than 3 wt %, less than 1 wt %, less than 0.5 wt %, less than 0.1 wt %, or no PA6,6 at all.

In certain aspects, the one or more polyamide polymers includes a PA6,10 polymer. PA6,10 has a lower water absorption when compared to PA6 or PA6,6 and is much stronger than PA11, PA12, or PA6,12, conveying significant advantages for use in applications requiring a balance of properties including strength, temperature resistance, reduced moisture uptake, as well as chemical resistance. The concentration of the PA6,10 polymer in the one or more polyamide polymers can, for example, range from 0 wt % to 100 wt %, e.g., from 0 wt % to 60 wt %, from 10 wt % to 70 wt %, from 20 wt % to 80 wt %, from 30 wt % to 90 wt %, or from 40 wt % to 100 wt %. In some embodiments, the one or more polyamide polymers includes from 25 wt % to 100 wt % PA6,10 polymer. In terms of upper limits, the PA6,10 polymer concentration in the one or more polyamide polymers can be less than 100 wt %, e.g., less than 90 wt %, less than 80 wt %, less than 70 wt %, less than 60 wt %, less than 50 wt %, less than 40 wt %, less than 30 wt %, less than 20 wt %, or less than 10 wt %. In terms of lower limits, the PA6,10 polymer concentration in the one or more polyamide polymers can be greater than 0 wt %, e.g., greater than 10 wt %, greater than 20 wt %, greater than 30 wt %, greater than 40 wt %, greater than 50 wt %, greater than 60 wt %, greater than 70 wt %, greater than 80 wt %, or greater than 90 wt %.

In certain aspects, the one or more polyamide polymers includes a PA6,12 polymer. The concentration of the PA6,12 polymer in the one or more polyamide polymers can, for example, range from 0 wt % to 100 wt %, e.g., from 0 wt % to 60 wt %, from 10 wt % to 70 wt %, from 20 wt % to 80 wt %, from 30 wt % to 90 wt %, or from 40 wt % to 100 wt %. In some embodiments, the one or more polyamide polymers includes from 0 wt % to 75 wt % PA6,12 polymer. In terms of upper limits, the PA6,12 polymer concentration in the one or more polyamide polymers can be less than 100 wt %, e.g., less than 90 wt %, less than 80 wt %, less than 70 wt %, less than 60 wt %, less than 50 wt %, less than 40 wt %, less than 30 wt %, less than 20 wt %, or less than 10 wt %. In terms of lower limits, the PA6,12 polymer concentration in the one or more polyamide polymers can be greater than 0 wt %, e.g., greater than 10 wt %, greater than 20 wt %, greater than 30 wt %, greater than 40 wt %, greater than 50 wt %, greater than 60 wt %, greater than 70 wt %, greater than 80 wt %, or greater than 90 wt %.

In certain aspects, the one or more polyamide polymers includes one of PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, or combinations thereof, and can, for example, range 0 wt % to 100 wt %, e.g., from 0 wt % to 60 wt %, from 10 wt % to 70 wt %, from 20 wt % to 80 wt %, from 30 wt % to 90 wt %, or from 40 wt % to 100 wt %. In some embodiments, the one or more polyamide polymers includes from 0 wt % to 75 wt % one of these polyamide polymers. In terms of upper limits, the concentration of these polyamide polymers can be less than 100 wt %, e.g., less than 90 wt %, less than 80 wt %, less than 70 wt %, less than 60 wt %, less than 50 wt %, less than 40 wt %, less than 30 wt %, less than 20 wt %, or less than 10 wt %. In terms of lower limits, the one of PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, or combinations thereof, polymer concentration in the one or more polyamide polymers can be greater than 0 wt %, e.g., greater than 10 wt %, greater than 20 wt %, greater than 30 wt %, greater than 40 wt %, greater than 50 wt %, greater than 60 wt %, greater than 70 wt %, greater than 80 wt %, or greater than 90 wt %.

The polyamide composition can include a combination of polyamides. By combining various polyamides, the final composition can incorporate the desirable properties, e.g., mechanical properties, of each constituent polyamides. The combination of polyamides could include any number of known polyamides. In some embodiments, the polyamide composition includes a combination of any of the polyamides previously described, preferably present in the amounts discussed herein. In an example aspect, the polyamide composition 6T/612 including dimer acid and/or dimer amine may have a ratio of 6T/612 that is about 50/50. The polyamide composition can also include combinations of any of the polymers in a range from 0 wt % to 100 wt %, e.g., from 0 wt % to 60 wt %, from 10 wt % to 70 wt %, from 20 wt % to 80 wt %, from 30 wt % to 90 wt %, or from 40 wt % to 100 wt %, as described herein.

In some embodiments, one or more low melt temperature polyamides are utilized, e.g., a polyamide having a melt temperature below 270° C., e.g., below 265° C., below 250° C., below 240° C., below 230° C., below 220° C., below 215° C. below 210° C., below 200° C., below 190° C., below 180° C., or below 175° C. The melt temperature of the one or more polyamides can each independently, for example, range from 165° C. to 270° C., e.g., from 165° C. to 220° C., from 170° C. to 215° C., from 175° C. to 215° C., from 180° C. to 215° C., from 185° C. to 225° C., from 205° C. to 245° C., from 225° C. to 265° C., or 240° C. to 270° C. In terms of lower limits, the melt temperature of each of the polyamides can be greater than 165° C., e.g., greater than 170° C., greater than 175° C., greater than 185° C., greater than 195° C., greater than 205° C., greater than 215° C., greater than 225° C., greater than 235° C., greater than 245° C., or greater than 255° C. Higher melt temperatures, e.g., greater than 265° C., and lower melt temperatures, e.g., less than 165° C., are also contemplated. In some embodiments, one or more amorphous polyamides are utilized, e.g., polyamides that do not have defined melting points.

The melting temperatures of the polyamide compositions including the modifier, a dimer acid or a dimer amine or a combination thereof, may range from 165° C. to 270° C. In some embodiments, a polyamide composition including PA6,12 and a modifier as described herein has a melting temperature in a range from 165° C. to 270° C. In other embodiments, e.g. a polyamide composition including PA6,10 and a modifier has a melting temperature in a range from 165° C. to 270° C. In yet other embodiments, e.g. a polyamide composition including PA6,6 and a modifier has a melting temperature in a range from 240° C. to 270° C.

In some embodiments, one or more low crystallization temperature polyamides are utilized, e.g., a polyamide having a crystallization temperature below 250° C., below 240° C., below 230° C., below 220° C., below 210° C., below 200° C., below 190° C., below 180° C., or below 175° C. The crystallization temperature of the one or more polyamides can each independently, for example, range from 100° C. to 240° C., e.g., from 110° C. to 230° C., from 110° C. to 200° C., from 110° C. to 190° C., from 110° C. to 180° C., from 150° C. to 230° C., from 160° C. to 230° C., or from 170° C. to 230° C. In terms of lower limits, the crystallization temperature of each of the polyamides can be greater than 100° C., e.g., greater than 110° C., greater than 120° C., greater than 130° C., greater than 140° C., greater than 150° C., greater than 160° C., or greater than 170° C. Higher crystallization temperatures, e.g., greater than 250° C., and lower crystallization temperatures, e.g., less than 100° C., are also contemplated. The one or more low crystallization temperature polyamides can have a range from 110° C. to 180° C., e.g., for PA6,10 and/or PA6,12, or from 170° C. to 230° C., e.g., for PA6,6.

In some embodiments, each of the one or more polyamide polymers is crystalline or semi-crystalline. In some embodiments, each of the one or more polyamide polymers is crystalline. In some embodiments, each of the one or more polyamide polymers is semi-crystalline.

In some embodiments, a polyamide having two components (copolymer) is utilized to provide a higher level of crystallinity, as compared with a polyamide of three components (terpolymer) or four components (tetrapolymer). The level of crystallinity may be determined by heat of fusion as measured by differential scanning calorimetry (DSC) and/or by the crystallization temperature as described above. In some embodiments, the polyamide is a copolymer having two components (two repeat units). Copolymers are preferred for applications requiring a higher level of crystallinity and/or a higher melting point. In other embodiments, the polyamide is a terpolymer having three components (three repeat units). In some embodiments, the polyamide is a tetrapolymer having four components (four repeat units). Tetrapolymers are preferred for applications for which a lower modulus and lower level of crystallinity is desired, e.g., for tubing.

In some embodiments, polyamide compositions herein include only a single modifier, e.g., dimer amine or dimer acid as described below. In some embodiments, polyamides include no greater than one modifier, wherein the modifier is a dimer acid or a dimer amine. The level of crystallinity may also be affected by having a single modifier as compared with providing two modifiers in the polyamide composition. For example, utilizing only one modifier can maintain a higher level of crystallinity, as well as other advantageous suitable for tubing, such as beneficial chemical resistance, dimensional stability, and gas barrier properties.

In other embodiments, a combination of a single dimer acid and a single dimer amine is utilized in the polyamide composition.

The number average molecular weight (Mₙ) of the one or more polyamide polymers in the polyamide composition can each independently, for example, range from 9,000 g/mol to 60,000 g/mol, e.g., from 9,000 g/mol to 12,000 g/mol, from 9,000 g/mol to 15,000 g/mol, from 9,000 g/mol to 20,000 g/mol, from 9,000 g/mol to 24,000 g/mol, from 9,000 g/mol to 25,000 g/mol, from 9,000 g/mol to 45,000 g/mol, from 10,000 g/mol to 20,000 g/mol, from 10,000 g/mol to 25,000 g/mol, from 10,000 g/mol to 30,000 g/mol, from 10,000 g/mol to 45,000 g/mol, from 12,000 g/mol to 20,000 g/mol, from 12,000 g/mol to 45,000 g/mol, from 13,000 g/mol to 18,000 g/mol, from 13,000 g/mol to 25,000 g/mol, from 15,000 g/mol to 30,000 g/mol, from 20,000 g/mol to 25,000 g/mol, from 20,000 g/mol to 35,000 g/mol, from 20,000 g/mol to 45,000 g/mol, from 30,000 g/mol to 45,000 g/mol, from 35,000 g/mol to 50,000 g/mol, from 40,000 g/mol to 55,000 g/mol, or from 45,000 g/mol to 60,000 g/mol. The use of lower Mₙ polyamides such as these is typically not contemplated in conventional film formulations, which typically range from 25,000 g/mol to 50,000 g/mol (or greater). In some embodiments, an injection molded article comprising any of the provided polyamide compositions is provided, where the number average molecular weight can be from 9,000 g/mol to 20,000 g/mol. In other embodiments, an extruded article of any of the provided polyamide compositions is provided and can be a profile extrusion article, a monofilament, a fiber, where the number average molecular weight can be from 20,000 g/mol to 45,000 g/mol.

In terms of upper limits, the one or more polyamide polymers can have a number average molecular weight less than 60,000 g/mol, e.g., less than 55,000 g/mol, less than 50,000 g/mol, less than 45,000 g/mol, less than 40,000 g/mol, less than 35,000 g/mol, less than 30,000 g/mol, less than 25,000 g/mol, less than 24,000 g/mol, less than 20,000 g/mol, less than 18,000 g/mol, less than 15,000 g/mol, less than 12,000 g/mol, or less than 10,000 g/mol. In terms of lower limits, the one or more polyamide polymers can have a number average molecular weight greater than 9,000 g/mol, e.g., greater than 10,000 g/mol, greater than 12,000 g/mol, greater than 13,000 g/mol, greater than 15,000 g/mol, greater than 20,000 g/mol, greater than 25,000 g/mol, greater than 30,000 g/mol, greater than 35,000 g/mol, greater than 40,000 g/mol, greater than 45,000 g/mol, greater than 50,000 g/mol, or greater than 55,000 g/mol. Higher molecular weights, e.g., greater than 60,000 g/mol, and smaller molecular weights, e.g., less than 9,000 g/mol, are also contemplated.

The one or more polyamides each independently have a specific configuration of end groups, such as, for example, amine end groups, carboxylate end groups and so-called inert end groups including mono-carboxylic acids, mono amines, lower dicarboxylic acids capable of forming inert imine end groups, phthalic acids and derivatives thereof. It has been found that in some aspects, the polymer end groups can be selected to specifically interact with the modifier of the composition, affecting dispersion and resulting mechanical properties. The polyamide polymer of the present disclosure can have an amine end group content, for example, ranging from 10 microeq/g to 110 microeq/g, e.g., from 20 microeq/g to 100 microeq/g, from 30 microeq/g to 90 microeq/g, or from 35 microeq/g to 80 microeq/g. In terms of upper limits, the polyamide polymer can have an amine end group content of less than 110 microeq/g, e.g., less than 100 microeq/g, less than 90 microeq/g, or less than 85 microeq/g. In terms of lower limits, the polyamide polymer can have an amine end group content of greater than 10 microeq/g, e.g., greater than 20 microeq/g, greater than 25 microeq/g, or greater than 30 microeq/g. In some embodiments wherein the number average molecular weight of the one or more polyamides is high, i.e., greater than about 30,000 g/mol, there can be lower concentrations of amine end groups. Generally, as the number average molecular weight increases, the amine end group content decreases.

In addition to the compositional make-up of the polyamide mixture, it has also been discovered that the relative viscosities of the one or more amide polymers can provide surprising benefits, both in performance and processing. For example, if the relative viscosity of the amide polymer is within certain ranges and/or limits, production rates and tensile strength (and optionally impact resilience) are improved. As described herein, “relative viscosity” or “RV” refers to a comparison of the viscosity of a solution of polymer in formic acid with the viscosity of the formic acid itself, and is measured using 90% formic acid and glass capillary Ubbelohde viscometers according to the standard protocol ASTM D789-18 (2018). For samples containing fiberglass or other fillers, the weight of sample to be dissolved is adjusted according to the amount of filler to provide the required 11.0 grams of neat resin per 100 ml formic acid. Solutions containing such fillers are filtered before loading into the viscometer.

The relative viscosity of the one or more polyamides can each independently or collectively, for example, range from 25 to 250, e.g., from 25 to 160, from 25 to 90, from 35 to 80, from 35 to 70, from 47.5 to 182.5, from 70 to 205, from 92.5 to 227.5, or from 115 to 250. In terms of upper limits, the polyamide relative viscosity can be less than 250, e.g., less than 227.5, less than 205, less than 182.5, less than 160, less than 137.5, less than 115, less than 92.5, less than 90, less than 80, less than 70, less than 65, less than 61, less than 57, less than 53, less than 49, less than 45, less than 41, less than 37, less than 33, or less than 29. In terms of lower limits, the polyamide relative viscosity can be greater than 25, e.g., greater than 29, greater than 33, greater than 35, greater than 37, greater than 41, greater than 45, greater than 49, greater than 53, greater than 57, greater than 61, greater than 65, greater than 70, greater than 92.5, greater than 115, greater than 137.5, greater than 160, greater than 182.5, greater than 205, greater than 227.5. Higher relative viscosities, e.g., greater than 250, and lower relative viscosities, e.g., less than 25, are also contemplated. Film formulations (and films) conventionally have a higher RV ranging from 80 to 280, depending upon being cast or blown. In contrast, the formulations and articles including molded and/or extruded articles described herein have a much lower relative viscosity, e.g., less than 80.

The viscosity number, e.g., for long chain polyamides and high temperature polyphthalamides as measured in sulfuric acid, of the one or more polyamides can each independently or collectively, for example, range from 65 to 350 cm³/g, e.g., from 65 to 160 cm³/g, from 85 to 200 cm³/g, from 100 to 250 cm³/g, from 150 to 300 cm³/g, or from 200 to 350 cm³/g. In terms of upper limits, the polyamide viscosity number can be less than 350 cm³/g, e.g., less than 325 cm³/g, less than 300 cm³/g, less than 275 cm³/g, less than 250 cm³/g, less than 225 cm³/g, less than 220 cm³/g, less than 215 cm³/g, less than 210 cm³/g, less than 205 cm³/g, less than 200 cm³/g, or less than 195 cm³/g. In terms of lower limits, the polyamide viscosity number can be greater than 65 cm³/g, e.g., greater than 70 cm³/g, greater than 75 cm³/g, greater than 80 cm³/g, greater than 85 cm³/g, greater than 90 cm³/g, greater than 95 cm³/g, greater than 100 cm³/g, greater than 105 cm³/g, greater than 110 cm³/g, greater than 115 cm³/g, greater than 120 cm³/g, greater than 125 cm³/g, greater than 130 cm³/g, greater than 135 cm³/g, greater than 140 cm³/g, greater than 145 cm³/g, greater than 150 cm³/g, greater than 155 cm³/g. Higher viscosity numbers, e.g., greater than 350 cm³/g, and lower viscosity numbers, e.g., less than 65 cm³/g, are also contemplated.

Dimer Acid/Dimer Amine Modifier

The polyamide composition of the present disclosure includes a modifier. The modifier of the present disclosure can include a dimer acid, or a dimer amine, or a combination thereof. A dimer acid may be a dicarboxylic acid. In some cases, dimer acids, or dimerized fatty acids, are dicarboxylic acids prepared by dimerizing unsaturated fatty acids obtained from tall oil, usually on clay catalysts. Dimer acids can include chemical intermediates made by dimerizing unsaturated fatty acids (e.g., oleic acid, linoleic acid, linolenic acid, ricinoleic acid) in the presence of a catalyst, such as a bentonite or montmorillonite clay. Commercially available dimer fatty acids are usually mixtures of products in which the dimerized product predominates. Some commercial dimer acids are made by dimerizing tall oil fatty acids. Dimer fatty acids may have 36 carbons and two carboxylic acid groups. They may be saturated or unsaturated. The dimer acids or dimer amines are, in some cases, hydrogenated to remove unsaturation for better performance.

Example dimer fatty acids include dimerized oleic acid, trimerized oleic acid, dimerized linoleic acid, trimerized linoleic acid, dimerized linolenic acid, trimerized linolenic acid, or mixtures thereof. In some cases, the dimer acid may be predominantly a dimer of stearic acid, also called C₃₆ dimer acid. The polyamide composition can include one or more dimer acids such as adipic acid, or may be devoid of adipic acid or substantially devoid of adipic acid. The polyamide polymer of the present disclosure can include one or more dimer acids of the systems, for example, containing at least 18, preferably from 18 to 44, carbons, ranging from C₁₈ (including 18 carbons) to C₄₄ (including 44 carbons), e.g., from C₁₈ to C₄₀, from Cao to C₃₈, or from C₂₂ to C₃₆. In terms of upper limits, the polyamide polymer can include one or more dimer acids of a C₄₄ system or less C in the chain, e.g., C₄₄ dimer acids, C₄₂ dimer acids, C₄₀ dimer acids, C₃₈ dimer acids, or C₃₆ dimer acids. In terms of lower limits, the polyamide polymer can include one or more dimer acids of a Cis system or greater C in the chain, e.g., Cis dimer acids, C₂₀ dimer acids, C₂₂ dimer acids, C₂₄ dimer acids, C₂₆ dimer acids, C₂₈ dimer acids, C₃₀ dimer acids, C₃₂ dimer acids, or C₃₄ dimer acids. Higher carbon dimer acids, e.g., greater than C₄₄, and lower carbon dimer acids, e.g., less than Cis, are also contemplated.

Dimer acids can be converted to dimer amines by reaction with ammonia and subsequent reduction, and can be an amine or amine derivative of a hydrocarbon-soluble polymerized fatty acid, particularly the class of dimer amines derived from dicarboxylic acids containing at least 12, preferably from 19 to 60, carbons. The polyamide composition can include one or more dimer acids and/or dimer amines, as in non-limiting examples, such as a C₃₆-unsaturated hydrogenated dimer acid such as PRIPOL™ 1009 having a molecular weight of about 570 g/mol and/or a dimer amine such as C₃₆ PRIAMINE™ 1074 or PPJAIVIINE™ 1075 having a molecular weight of about 540 g/mol (each available from Croda Inc., USA).

Using a dimer acid and/or a dimer amine has been found to provide tailorable functionality to the overall polyamide composition while maintaining original, desired functionality of the polyamides described above. To attain desired properties a single dimer acid or a single dimer amine can be utilized in the polyamide composition. In some embodiments, the polyamide composition includes a single dimer acid. In some embodiments, the polyamide composition includes a single dimer amine. In other embodiments, the polyamide composition includes at least one dimer acid or at least one dimer amine or a combination thereof.

The concentration of the modifier the overall polyamide composition can, for example, range from 5 wt % to 55 wt %, e.g., from 5 wt % to 10 wt %, from 15 wt % to 20 wt %, from 20 wt % to 30 wt %, from 25 wt % to 35 wt %, from 30 wt % to 40 wt %, from 15 wt % to 50 wt %, from 20 wt % to 45 wt %, 35 wt % to 55 wt %, from 35 wt % to 45 wt %, from 40 wt % to 50 wt %, from 45 wt % to 55 wt %, or any subranges thereof. In terms of upper limits, the modifier concentration can be less than 55 wt %, e.g., less than 50 wt %, less than 45 wt %, less than 40 wt %, less than 35 wt %, less than 30 wt %, less than 25 wt %, less than 20 wt %, less than 15 wt %, or less than 10 wt %. In terms of lower limits, the combined polyamide polymer concentration can be greater than 5 wt %, e.g., greater than 10 wt %, greater than 15 wt %, greater than 20 wt %, greater than 25 wt %, greater than 30 wt %, greater than 35 wt %, greater than 40 wt %, greater than 45 wt %, or greater than 50 wt %. Lower concentrations, e.g., less than 5 wt %, and higher concentrations, e.g., greater than 55 wt %, are also contemplated.

### Formulas

In certain embodiments, the polyamide composition includes one or more of the polyamides of the Formulas (1)-(6) below:

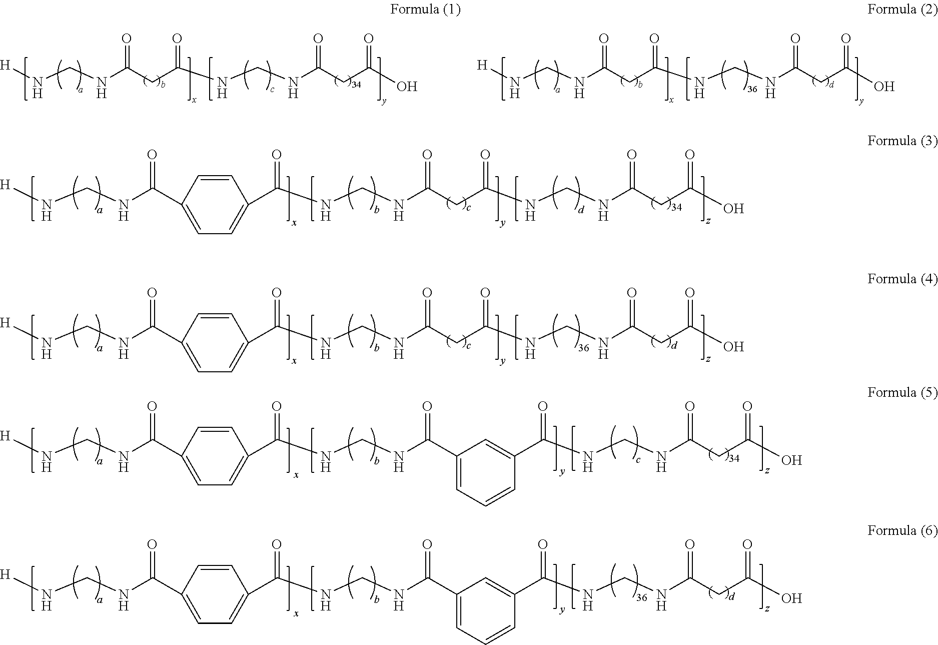

In the above Formulas (1) and (2), X+Y=100 wt % for the copolymers. In the above Formulas (3)-(6), X+Y+Z=100 wt % for the terpolymers. In the above Formulas (1)-(6), a=2-18, b=2-18, c=2-18, and d=2-18. In other embodiments, four separate monomers (2 acids and 2 amines) are used resulting in tetrapolymers. Alternatively, in yet other embodiments, formulations can include dimer amine and dimer acid in the same polymer.

In some embodiments, the polyamide composition contains AA-BB type polyamides. In some embodiments, the polyamide composition contains 5 to 55 wt % of the dimer acid and/or dimer amine repeat units and 45 to 95 wt % of AA-BB repeat units. The polyamide composition can, for example, contain dimer acid and/or dimer amine repeat units in a range from 5 wt % to 55 wt %, e.g., from 5 wt % to 15 wt %, from 10 wt % to 20 wt %, from 15 wt % to 25 wt %, from 20 wt % to 30 wt %, from 25 wt % to 35 wt %, from 30 wt % to 40 wt %, from 35 wt % to 45 wt %, from 40 wt % to 50 w %, from 45 wt % to 55 wt %, or any subranges thereof. In some embodiments, the polyamide composition can contain dimer acid and/or dimer amine repeat units in a range from 15 wt % to 50 wt %, from 20 wt % to 45 wt %, from 35 wt % to 55 wt %, or any subranges thereof. In terms of upper limits, the polyamide composition can, for example, contain dimer acid and/or dimer amine repeat units in an amount be less than 55 wt %, e.g., less than 50 wt %, less than 45 wt %, less than 40 wt %, less than 35 wt %, less than 30 wt %, less than 25 wt %, less than 20 wt %, less than 15 wt %, or less than 10 wt %. In terms of lower limits, the polyamide composition can, for example, contain dimer acid and/or dimer amine repeat units in an amount greater than 5 wt %, e.g., greater than 10 wt %, greater than 15 wt %, greater than 20 wt %, greater than 25 wt %, greater than 30 wt %, greater than 35 wt %, greater than 40 wt %, greater than 45 wt %, or greater than 50 wt %. Lower amounts of dimer acid and/or dimer amine repeat units, e.g., less than 5 wt %, and higher amounts, e.g., greater than 55 wt %, are also contemplated.

The polyamide composition can, for example, can contain AA-BB repeat units in a range from, for example, range from 45 to 95 wt %, e.g., from 45 wt % to 55 wt %, from 50 wt % to 60 wt %, from 55 wt % to 65 wt %, from 60 wt % to 70 wt %, from 65 wt % to 75 wt %, from 70 wt % to 80 wt %, from 75 wt % to 85 wt %, from 80 wt % to 90 wt %, from 85 wt % to 95 wt %, or any subranges thereof. In terms of upper limits, the polyamide composition can, for example, contain AA-BB repeat units in an amount be less than 95 wt %, e.g., less than 90 wt %, less than 85 wt %, less than 80 wt %, less than 75 wt %, less than 70 wt %, less than 65 wt %, less than 60 wt %, less than 55 wt %, or less than 50 wt %. In terms of lower limits, the polyamide composition can, for example, contain AA-BB repeat units in an amount greater than 45 wt %, e.g., greater than 50 wt %, greater than 55 wt %, greater than 60 wt %, greater than 65 wt %, greater than 70 wt %, greater than 75 wt %, greater than 80 wt %, greater than 85 wt %, or greater than 90 wt %. Lower amounts of AA-BB repeat units, e.g., less than 45 wt %, and higher amounts, e.g., greater than 95 wt %, are also contemplated.

The AA-BB repeating unit may be selected from the product prepared from a dicarboxylic acid and a diamine and includes, but is not limited to, PA6,6; PA6,9; PA6,10; PA6,12; PA 6,18; PA 9,6; PA 10,6; PA10,9: PA10,10; and PA10,12. Additionally, the repeating unit may be selected from the product prepared from a polyphthalamide and includes, but is not limited to, PA6,T/6,6; PA6,T/6,I; and PA6,T/D,T.

The molecular structure of PA6,12-hydrogenated dimer acid and PA6,12-hydrogenated hydrogenated dimer amine are shown in Formulas (A) and (B), respectively, below.

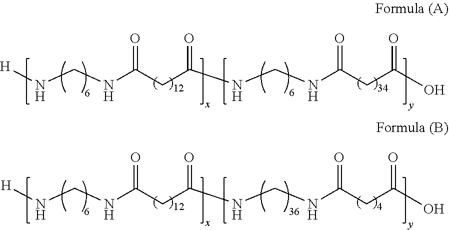

### Methyl/Amide Ratio

The polyamide composition including the modifier, a dimer acid or a dimer amine or a combination thereof, may have a dimer concentration as measured by methyl/amide ratios. The methyl/amide ratio is believed to be important because by making the backbone more aliphatic with more CH₂ (methylene) groups between the amides, the resulting chains have much greater flexibility due to the free range of motion they exhibit as they are not confined by the amide linkage; in other words, Brownian motion of the chains increases as the amide functionality decreases. Additionally, the methyl groups are hydrophobic and do not associate with water. While films are not concerned with moisture uptake, the polyamide compositions for non-film applications herein have methyl/amide ratios that are surprisingly beneficial and provide low moisture uptake and high chemical resistance. Further, the methyl/amide ratios can be tailored so that the polyamide compositions can handle either very basic or very acidic environments to provide the best chemical resistance in a particular environment. Hence, the more dilute the amide ratios become, the lower the potential for moisture uptake. By combining the polyamide polymer with the dimer acid and/or the dimer amine, the methyl/amide ratio is manipulated. By increasing the methyl/amide ratio, it is believed that resulting polyamide composition with have increased flexibility, increased chemical resistance, and reduced moisture uptake. The polyamide composition can, for example, have a methyl/amide ratio range from 6:1 to 15:1, e.g., from 6:1 to 9:1, from 6:1 to 12:1, from 9:1 to 12:1, from 9:1 to 15:1, or from 12:1 to 15:1. The polyamide composition having a methyl/amide ratio ranging from 6:1 to 15:1 can be, for example, PA6,6 or PA6,12. This may be explained and calculated from the backbone structure. In the case of PA6,6, there are two amide linkages and 12 carbons in each repeat unit, providing a ratio of 12/2 or 6:1. In the case of PA6,12, there are two amide linkages and 18 carbons in each repeat unit, providing a ratio of 18/2 or 9:1. In an embodiment having a PA6,12-s-PA6,36 system, the methyl/amide ratio can be calculated via the mol % of each component. For example, in the case of a 75/25 PA6,12 to PA6,36 composition, the methyl/amide ratio is 12:1.

The polyamide composition can be PA6,6 having a methyl/amide ratio of about 6:1 or greater. In other embodiments, the polyamide composition has a methyl/amide ratio ranging from 9:1 to 15:1. The polyamide composition can be PA6,12 having a methyl/amide ratio ranging from about 9:1 or greater. The inventors have surprisingly found, for example, a polyamide composition including PA6,12 with a dimer modifier content of up to about 45 wt % may result in the methyl/amide ratio increasing from 9:1 (without modifier) to 12:1. Any of the polyamide polymers disclosed herein may be used and can have a methyl/amide ratio of from 6:1 to 15:1. As the amount of modifier of dimer acid and/or dimer amine is increased, the methyl/amide ratio is also increased. The increase in methyl/amide ratio yields advantages, such as increased chemical resistance, reduced moisture uptake, increased mechanical properties (i.e., elongation, impact resilience, abrasion resistance), better clarity, UV resistance, and others.

### Glass Fiber

The polyamide composition optionally includes a reinforcing filler, e.g., glass fiber. The glass fiber can include soda lime silicate, zirconium silicates, calcium borosilicates, alumina-calcium borosilicates, calcium aluminosilicates, magnesium aluminosilicates, or combinations thereof. The glass fiber can include long fibers, e.g., greater than 6 mm, short fibers, e.g., less than 6 mm, or combinations thereof. The glass fiber can be milled.

The amount of glass fiber in the polyamide composition relative to the amounts of the other composition components can be selected to advantageously provide additional strength without negatively affecting material ductility. The concentration of glass fiber in the polyamide composition can, for example, range from 0 wt % to 60 wt %, e.g., from 0 wt % to 30 wt %, from 5 wt % to 35 wt %, from 10 wt % to 40 wt %, from 15 wt % to 45 wt %, from 20 wt % to 50 wt %, from 25 wt % to 55 wt %, or from 30 wt % to 60 wt %. In some embodiments, the concentration of glass fiber ranges from 20 wt % to 40 wt % e.g., from 25 wt % to 35 wt %, from 27 wt % to 33 wt %, from 28 wt % to 32 wt %, or from 29 wt % to 31 wt %. In certain aspects, the concentration of glass fiber ranges from 20 wt % to 40 wt %. In terms of upper limits, the glass fiber concentration can be less than 60 wt %, e.g., less than 55 wt %, less than 50 wt %, less than 45 wt %, less than 40 wt %, less than 35 wt %, less than 33 wt %, less than 32 wt %, or less than 31 wt %, less than 30 wt %, less than 25 wt %, less than 20 wt %, less than 15 wt %, less than 10 wt %, or less than 5 wt %. In terms of lower limits, the glass fiber concentration can be greater than 0 wt %, e.g., greater than 5 wt %, greater than 10 wt %, greater than 15 wt %, greater than 20 wt %, greater than 25 wt %, greater than 27 wt %, greater than 28 wt %, greater than 29 wt %, greater than 30 wt %, greater than 35 wt %, greater than 40 wt %, greater than 45 wt %, greater than 50 wt %, or greater than 55 wt %. Higher concentrations, e.g., greater than 60 wt %, are also contemplated. In aspects, the concentration of glass fiber in the polyamide composition is present in an amount greater than 5 wt %.

The additive of reinforcing filler is important to the polyamide compositions described herein because the reinforcing filler, e.g., glass fibers, contributes to the strength and performance of the resultant articles such as extruded article, a profile extrusion article, a monofilament, or a fiber. In contrast, polyamides for film applications do not include glass and are devoid or substantially devoid of glass and/or glass fibers.

### Melt Stabilizer/Lubricant

The polyamide composition can include one or more melt stabilizers (lubricants). The type and relative amount of melt stabilizer can be selected to improve processing of the composition, and to contribute to the simultaneously high strength and ductility of the material. The concentration of lubricant in the polyamide composition can, for example, range from 0 wt % to 2 wt %, e.g., from 0.1 wt % to 0.5 wt %, from 0.1 wt % to 0.6 wt %, from 0.1 wt % to 1.0 wt %, from 0.1 wt % to 1.5 wt %, from 0.1 wt % to 2.0 wt %, from 0.5 wt % to 1.0 wt %, from 0.5 wt % to 1.5 wt %, or from 0.5 wt % to 2.0 wt %. In terms of upper limits, the lubricant concentration can be less than 2.0 wt %, e.g., less than 1.8 wt %, less than 1.6 wt %, less than 1.5 wt %, less than 1.4 wt %, less than 1.2 wt %, less than 1.0 wt %, less than 0.8 wt %, less than 0.6 wt %, less than 0.5 wt %, less than 0.4 wt %, less than 0.3 wt %, less than 0.2 wt %, or less than 0.1 wt %. In terms of lower limits, the lubricant concentration can be greater than 0 wt %, e.g., greater than 0.1 wt %, greater than 0.2 wt %, greater than 0.3 wt %, greater than 0.4 wt %, greater than 0.5 wt %, greater than 0.6 wt %, greater than 0.8 wt %, greater than 1.0 wt %, greater than 1.2 wt %, greater than 1.4 wt %, greater than 1.5 wt %, greater than 1.6 wt %, or greater than 1.8 wt %. Higher concentrations, e.g., greater than 2.0 wt %, are also contemplated.

In some embodiments, the melt stabilizer comprises a saturated fatty acid. For example the melt stabilizer may comprise stearic acid, behenic acid, or combinations thereof, or salts thereof. In some cases, the melt stabilizer comprises a stearate. The melt stabilizer, in some cases can include, for example, zinc stearate, calcium stearate, aluminum distearate, zinc stearate, calcium stearate, N,N′ ethylene bis-stearamide, stearyl erucamide. In some cases, the melt stabilizer is a stearate combined with a wax, e.g., a saponified ester wax. In some embodiments, the melt stabilizer does not include an ionic lubricant.

In some embodiments, the melt stabilizer may be a wax. In some embodiments, the melt stabilizer consists of a wax. In some embodiments, the wax includes a fatty acid. In some embodiments, the melt stabilizer consists of a fatty acid. In some embodiments, the wax includes a saturated fatty acid. In some embodiments, the melt stabilizer consists of a saturated fatty acid. In some embodiments, the wax includes stearic acid, behenic acid, or salts or combinations thereof. In some embodiments, the wax consists of stearic acid, behenic acid, or salts or combinations thereof. In some embodiments, the wax is saponified ester wax. For example, suitable for polyamide compositions herein is Montan wax, which is a saponified ester wax including dimerized alkyl chains as saponified, having a molecular weight of about 824 g/mol.

In some cases, the wax is a saponified ester wax combined with a stearate. In some embodiments, the wax is a Montan wax and is further combined with a metal stearate, such as aluminum distearate or zinc stearate.

In some cases, the compositions employ waxes that have alkyl portions or tails are that are significantly longer than for stearates, e.g., 40% longer. For example, Montan waxes having C₂₈ portions are desirable in the polyamide compositions herein because the higher chain length makes them more efficacious lubricants with the longer chain polymers. In some embodiments, the lubricant includes a chain length greater than C₁₈, greater than C₂₀, greater than C₂₂, greater than C₂₄, greater than C₂₆, or greater than C₂₈. In some embodiments, a C₂₈ lubricant is employed in the polyamide compositions herein. Stearates, e.g., aluminum distearate, zinc stearate, calcium stearate, or combinations thereof, are not suitable for use alone, but may be suitable in combinations with another lubricant such as described above.

Specifically, the polyamide compositions, in some embodiments, do not include stearate waxes such as ethylenebisstearamide (EBS), commonly sold as Akrowax® and having a molecular weight of about 593 g/mol and having a C₁₈ chain length. Specifically, the polyamide compositions, in some embodiments, do not include stearic acid. In some embodiments, the polyamide compositions do not include stearyl erucamide. In some embodiments, the polyamide compositions do not include C₁₈ stearates. This is because the shorter chain C₁₈ stearates are more compatible with PA6 or PA6,6 formulations for film applications than for the molded or extruded articles herein utilizing longer chain polymers. Importantly, C₁₈ stearate wax/lubricant, e.g., EBS wax, is necessary as a compatibilizer with film monomers. EBS wax is unsuitable for the polyamide compositions herein, which are devoid of EBS wax. This is important because, while EBS may be useful in film formulations or in PA6 type polymers, EBS wax is not suitable in non-film formulations disclosed herein having more hydrophobic, long chain polymers. EBS wax simply does not blend with the surface of the long chain polyamides herein. Polyamide compositions herein are devoid or substantially devoid of EBS wax, stearyl erucamide, and/or C₁₈ stearates. In some embodiments, the polyamide compositions herein disclosed are devoid or substantially devoid of shorter chain length lubricants, EBS wax, stearyl erucamide, C₁₈ stearates, and combinations thereof, e.g., contain less than 5 wt %, less than 3 wt %, less than 1 wt %, less than 0.5 wt %, less than 0.1 wt %, or no shorter chain length lubricants, EBS wax, stearyl erucamide, C₁₈ stearates, and combinations thereof at all. In some cases, the melt stabilizer does not include stearyl erucamide, aluminum distearate, zinc stearate, calcium stearate, or combinations thereof, e.g., less than 1.0 wt %, less than 0.5 wt %, less than 0.1 wt % or none at all. In some cases, stearyl erucamide, aluminum distearate, zinc stearate, calcium stearate, or combinations thereof are only present in combination with another wax lubricant, such as Montan wax.

In some embodiments, the polyamide compositions include a lubricant or melt stabilizer having a molecular weight range of, for example, from 600 g/mol to 1200 g/mol, e.g., from 600 g/mol to 800 g/mol, 800 g/mol to 1000 g/mol, or 1000 g/mol to 1200 g/mol. In terms of upper limits, the lubricant or melt stabilizer molecular weight can be less 1200 g/mol, e.g., less than 1100 g/mol, less than 1000 g/mol, less than 900 g/mol, less than 800 g/mol, or less than 700 g/mol. In terms of lower limits, the lubricant or melt stabilizer molecular weight can be greater than 600 g/mol, e.g., greater than 700 g/mol, greater than 800 g/mol, greater than 900 g/mol, greater than 1000 g/mol, or greater than 1100 g/mol. Lower molecular weights, e.g., less than 600 g/mol, and molecular weights, e.g., greater than 1200 g/mol are also contemplated. In some embodiments, the polyamide compositions herein disclosed are devoid or substantially devoid of lower molecular weight lubricants, e.g., having a molecular weight less than 800 g/mol, or less than 700 g/mol, or less than 600 g/mol, e.g., contain less than 5 wt %, e.g., less than 3 wt %, less than 1 wt %, less than 0.5 wt %, less than 0.1 wt %, or no lower molecular weight lubricants at all.

In addition to other performance improvements, the disclosed melt stabilizers, also significantly improve dispersion of the components in the matrix of the polymer, e.g., the dispersion of the impact modifiers in the polyamide matrix, which beneficially improves impact performance.

The concentration of the melt stabilizer, e.g., stearic acid or salt thereof, in the polyamide composition can, for example, range from 0.01 wt % to 0.7 wt %, e.g., from 0.01 wt % to 0.1 wt %, from 0.05 wt % to 0.2 wt %, from 0.1 wt % to 0.3 wt %, from 0.1 wt % to 0.6 wt %, from 0.2 wt % to 0.4 wt %, from 0.3 wt % to 0.5 wt %, from 0.4 wt % to 0.6 wt %, or from 0.5 wt % to 0.7 wt %. In terms of upper limits, the melt stabilizer concentration can be less than 0.7 wt %, e.g., less than 0.6 wt %, less than 0.5 wt %, less than 0.4 wt %, less than 0.3 wt %, less than 0.2 wt %, less than 0.1 wt %, less than 0.05 wt %, less than 0.03 wt %, or less than 0.02 wt %. In terms of lower limits, the stearic acid or salt concentration can be greater than 0.01 wt %, e.g., greater than 0.02 wt %, greater than 0.03 wt %, greater than 0.05 wt %, greater than 0.1 wt %, greater than 0.2 wt %, greater than 0.3 wt %, greater than 0.4 wt %, greater than 0.5 wt %, or greater than 0.6 wt %. Higher concentrations, e.g., greater than 0.7 wt %, and lower concentrations, e.g., less than 0.01 wt %, are also contemplated. Suitable melt stabilizers or lubricants may be chosen from N,N′ ethylene bis-stearamide, stearyl erucamide, aluminum distearate, zinc stearate, montan waxes, or combinations thereof. In certain embodiments employing a combination of lubricants, for example, 0.3-0.4 wt % stearyl erucamide is mixed with 0.1-0.2 wt % aluminum or zinc stearate. Lower or higher amounts of lubricants can be used tailored to the application for use.

In some preferred embodiments, a stearate or a metal stearate, e.g., aluminum distearate and/or zinc stearate, is mixed with a saponified ester wax, e.g., Montan waxes, as lubricants.

In aspects, polyamide compositions herein include that lubricant is present in an amount greater than 0.1 wt %, or greater than 0.2 wt %, or greater than 0.3 wt %. Compositions as disclosed herein may comprise at least about 0.3 wt % lubricant, not typical and not present in a film composition. In the case of injection molding, lubricant amounts are preferably from about 0.3 to about 0.6%.

The additive of lubricant or melt stabilizer is important to the polyamide compositions described herein because the lubricant or melt stabilizer, e.g., glass fibers, contributes to the strength and performance of the resultant articles such as extruded article, a profile extrusion article, a monofilament, or a fiber. In contrast, polyamides for film applications do not include higher molecular weight lubricants and are devoid or substantially devoid of higher molecular weight lubricants.

### Color Package (Nigrosine/Carbon Black)

The polyamide composition can include one or more colorants, e.g., soluble dyes such as nigrosine (0.5%, 30% active) or solvent black 7. The concentration of the nigrosine in the polyamide composition can, for example, range from 0.1 to 5 wt %, e.g., from 0.1 wt % to 1 wt %, from 0.15 wt % to 1.5 wt %, from 0.22 wt % to 2.3 wt %, from 0.32 wt % to 3.4 wt %, or from 0.48 wt % to 5.0 wt %. In some embodiments, the concentration of the nigrosine ranges from 1.0 wt % to 2.0 wt %, e.g., from 1.0 wt % to 1.6 wt %, from 1.1 wt % to 1.7 wt %, from 1.2 wt % to 1.8 wt %, from 1.3 wt % to 1.9 wt %, or from 1.4 wt % to 2.0 wt %. In terms of upper limits, the nigrosine concentration can be less than 5.0 wt %, e.g., less than 3.4 wt %, less than 2.3 wt %, less than 2.0 wt %, less than 1.9 wt %, less than 1.8 wt %, less than 1.7 wt %, less than 1.6 wt %, less than 1.5 wt %, less than 1.4 wt %, less than 1.3 wt %, less than 1.2 wt %, less than 1.1 wt %, less than 1.0 wt %, less than 0.71 wt %, less than 0.48 wt %, less than 0.32 wt %, less than 0.22 wt %, or less than 0.15 wt %. In terms of lower limits, the nigrosine concentration can be greater than 0.1 wt %, e.g., greater than 0.15 wt %, greater than 0.22 wt %, greater than 0.32 wt %, greater than 0.48 wt %, greater than 0.71 wt %, greater than 1.0 wt %, greater than 1.1 wt %, greater than 1.2 wt %, greater than 1.3 wt %, greater than 1.4 wt %, greater than 1.5 wt %, greater than 1.6 wt %, greater than 1.7 wt %, greater than 1.8 wt %, greater than 1.9 wt %, greater than 2.0 wt %, greater than 2.3 wt %, or greater than 3.4 wt %. Lower concentrations, e.g., less than 0.1 wt %, and higher concentrations, e.g., greater than 5.0 wt %, are also contemplated. In some cases, the nigrosine is provided in a masterbatch, and the concentration of the nigrosine or dye in the masterbatch and in the resultant composition can be easily calculated.

The polyamide composition can include one or more particulates such as carbon black (0.5%, 35% active). The concentration of the carbon black in the polyamide composition can, for example, range from 0.1 to 5.0 wt %, e.g., from 0.1 wt % to 1.0 wt %, from 0.15 wt % to 1.5 wt %, from 0.22 wt % to 2.3 wt %, from 0.32 wt % to 3.4 wt %, or from 0.48 wt % to 5.0 wt %. In some embodiments, the concentration of the carbon black ranges from 1.0 wt % to 2.0 wt %, e.g., from 1.0 wt % to 1.6 wt %, from 1.1 wt % to 1.7 wt %, from 1.2 wt % to 1.8 wt %, from 1.3 wt % to 1.9 wt %, or from 1.4 wt % to 2.0 wt %. In terms of upper limits, the carbon black concentration can be less than 5.0 wt %, e.g., less than 3.4 wt %, less than 2.3 wt %, less than 2.0 wt %, less than 1.9 wt %, less than 1.8 wt %, less than 1.7 wt %, less than 1.6 wt %, less than 1.5 wt %, less than 1.4 wt %, less than 1.3 wt %, less than 1.2 wt %, less than 1.1 wt %, less than 1.0 wt %, less than 0.71 wt %, less than 0.48 wt %, less than 0.32 wt %, less than 0.22 wt %, or less than 0.15 wt %. In terms of lower limits, the carbon black concentration can be greater than 0.1 wt %, e.g., greater than 0.15 wt %, greater than 0.22 wt %, greater than 0.32 wt %, greater than 0.48 wt %, greater than 0.71 wt %, greater than 1.0 wt %, greater than 1.1 wt %, greater than 1.2 wt %, greater than 1.3 wt %, greater than 1.4 wt %, greater than 1.5 wt %, greater than 1.6 wt %, greater than 1.7 wt %, greater than 1.8 wt %, greater than 1.9 wt %, greater than 2.0 wt %, greater than 2.3 wt %, or greater than 3.4 wt %. Lower concentrations, e.g., less than 0.1 wt %, and higher concentrations, e.g., greater than 5.0 wt %, are also contemplated. In some cases, the carbon black is provided in a masterbatch, and the concentration of the carbon black in the masterbatch and in the resultant composition can be easily calculated.

The weight ratio of the one or more polyamide polymers to the nigrosine and/or carbon black in the polyamide composition can, for example, range from 1 to 85, e.g., from 1 to 14, from 1.6 to 22, from 2.4 to 35, from 3.8 to 55, or from 5.9 to 85. In terms of upper limits, the ratio of the one or more polyamide polymers to the nigrosine can be less than 85, e.g., less than 55, less than 35, less than 22, less than 14, less than 9.2, less than 5.9, less than 3.8, less than 2.4, or less than 1.6. In terms of lower limits, the ratio of the one or more polyamide polymers to the nigrosine can be greater than 1, e.g., greater than 1.6, greater than 2.4, greater than 3.8, greater than 5.9, greater than 9.2, greater than 14, greater than 22, greater than 35, or greater than 55. Higher ratios, e.g., greater than 55, and lower ratios, e.g., less than 1, are also contemplated.

The polyamide composition can include one or more pigments such as carbon black. The concentration of the carbon black in the polyamide composition can, for example, range from 0.1 to 5.0 wt %, e.g., from 0.1 wt % to 1.05 wt %, from 0.15 wt % to 1.55 wt %, from 0.22 wt % to 2.29 wt %, from 0.32 wt % to 3.38 wt %, or from 0.48 wt % to 5.0 wt %. In some embodiments, the concentration of the carbon black ranges from 0.2 wt % to 0.8 wt %. In terms of upper limits, the carbon black concentration can be less than 5.0 wt %, e.g., less than 3.4 wt %, less than 2.3 wt %. less than 1.5 wt %, less than 1.0 wt %, less than 0.71 wt %, less than 0.48 wt %, less than 0.32 wt %, less than 0.22 wt %, or less than 0.15 wt %. In some embodiments, the concentration of the carbon black is less than 3.0 wt %. In terms of lower limits, the carbon black concentration can be greater than 0.1 wt %, e.g., greater than 0.15 wt %, greater than 0.22 wt %, greater than 0.32 wt %, greater than 0.48 wt %, greater than 0.71 wt %, greater than 1.0 wt %, greater than 1.5 wt %, greater than 2.3 wt %, or greater than 3.4 wt %. Lower concentrations, e.g., less than 0.1 wt %, and higher concentrations, e.g., greater than 5.0 wt %, are also contemplated.

In aspects, the concentration of colorant in the polyamide composition is present in an amount greater than 0.1 wt %.

The additive of colorant is important to the polyamide compositions described herein because the colorant, e.g., nigrosine and/or carbon black, contributes to the performance of the resultant articles such as extruded article, a profile extrusion article, a monofilament, or a fiber. In contrast, polyamides for film applications do not include colorant colorants, as film applications are concerned with transparency.

### Mineral Filler

The polyamide composition optionally includes a filler, e.g., a mineral filler that is inorganic. The inorganic mineral filler can include one or more of dolomite, silica, calcium carbonate, magnesium hydroxide, zinc borate, talc, vermiculite, diatomite, perlite, wollastonite, fly ash, kaolin clay, mica, or titanium dioxides, calcium carbonate, magnesium hydroxide, talc, wollastonite, fly ash, or combinations thereof.

The amount of mineral filler in the polyamide composition relative to the amounts of the other composition components can be selected to advantageously balance melt strength and formability. The concentration of mineral filler in the polyamide composition can, for example, range from 0 wt % to 30 wt %, e.g., from 0 wt % to 10 wt %, from 5 wt % to 15 wt %, from 10 wt % to 20 wt %, from 15 wt % to 25 wt %, or from 20 wt % to 30 wt %. In terms of upper limits, the mineral filler concentration can be less than 30 wt %, e.g., less than 25 wt %, less than 20 wt %, less than 15 wt %, less than 10 wt %, or less than 5 wt %. In terms of lower limits, the mineral filler concentration can be greater than 0 wt %, e.g., greater than 5 wt %, greater than 10 wt %, greater than 15 wt %, greater than 20 wt %, greater than 25 wt %, or greater than 30 wt %. Higher concentrations, e.g., greater than 30 wt %, are also contemplated.

### Impact Modifier

The polyamide compositions disclosed herein include one or more impact modifiers. In some cases, the impact modifier comprises olefins, acrylates, or acrylics, or combinations thereof, including polymers of these compounds such as polyolefins or polyacrylates. These compounds may be unmodified or modified, e.g., modified (grafted) with maleic anhydride. In some embodiments, the impact modifier comprises a maleic anhydride-modified olefin, maleic anhydride-unmodified olefin, acrylate, or acrylic, or combinations thereof. In some cases, the impact modifier comprises a modified olefin, e.g., a maleic anhydride-modified olefin. The impact modifier may comprise a maleic anhydride-modified ethylene octene and/or ethylene acrylate.

In some embodiments, the impact modifier has a glass transition temperature ranging from ranging from 0° C. to −100° C., e.g., from −5° C. to −80° C., −10° C. to −70° C., −20° C. to −60° C., or from −25° C. to −55° C. In terms of lower limits, the impact modifier may have a glass transition temperature greater than −100° C., e.g., greater than −80° C., greater than −70° C., greater than −60° C., or greater than −55° C. In terms of upper limits, the impact modifier may have a glass transition temperature less than 0° C., e.g., less than −5° C., less than −10° C., less than −15° C., or less than −25° C. It is believed that impact modifiers having such glass transition temperatures synergistically improve energy dissipation characteristics, e.g., impact resistance. These particular impact modifiers have glass transition temperatures in temperature ranges that work with the disclosed polyamides and glass fibers to achieve improved impact performance, especially in the desired temperature ranges, e.g., −10° C. to −70° C.

In some embodiments, the impact modifier can include a styrenic copolymer such as an acrylate-butadiene-styrene or a methyl methacrylate-butadiene-styrene. The impact modifier can include an acrylic polymer or a polyethylene polymer such as a chlorinated polyethylene. In some embodiments, the impact modifier includes an ethylene-octene copolymer. In some cases, the combination of the impact modifier and the melt stabilizers (optionally in the disclosed amounts and ratios) provides for surprising, synergistic combinations of performance features, e.g., tensile/flexural performance and impact resistance.

The concentration of the impact modifier in the polyamide composition can, for example, range from 3 wt % to 30 wt %, e.g., from 3 wt % to 19.2 wt %, from 3 wt % to 25 wt %, from 3 wt % to 20 wt %, from 5.7 wt % to 21.9 wt %, from 4.0 wt % to 15 wt %, from 5.5 wt % to 14 wt %, from 6.0 wt % to 11.5 wt %, from 8.4 wt % to 24.6 wt %, from 11.1 wt % to 27.3 wt %, or from 13.8 wt % to 30 wt %. In some embodiments, the concentration of the impact modifier ranges from 6 wt % to 20 wt %, e.g., from 6 wt % to 14.4 wt %, from 7.4 wt % to 15.8 wt %, from 8.8 wt % to 17.2 wt %, from 10.2 wt % to 18.6 wt %, or from 11.6 wt % to 20 wt %. In terms of upper limits, the impact modifier concentration can be less than 30 wt %, e.g., less than 27.3 wt %, less than 25.0 wt %, less than 24.6 wt %, less than 21.9 wt %, less than 20 wt %, less than 18.6 wt %, less than 17.2 wt %, less than 15.8 wt %, less than 15 wt %, less than 14 wt %, less than 14.4 wt %, less than 13 wt %, less than 11.6 wt %, less than 11.5 wt %, less than 10.2 wt %, less than 8.8 wt %, less than 7.4 wt %, less than 6 wt %, or less than 5.4 wt %. In terms of lower limits, the impact modifier concentration can be greater than 3 wt %, greater than 4.0 wt %, greater than 5.5 wt %, greater than 5.4 wt %, greater than 6 wt %, greater than 7.4 wt %, greater than 8.8 wt %, greater than 10.2 wt %, greater than 11.6 wt %, greater than 13 wt %, greater than 14.4 wt %, greater than 15.8 wt %, greater than 17.2 wt %, greater than 18.6 wt %, greater than 20 wt %, greater than 21.9 wt %, greater than 24.6 wt %, greater than 25.0 wt %, or greater than 27.6 wt %. Lower concentrations, e.g., less than 3 wt %, and higher concentrations, e.g., greater than 30 wt %, are also contemplated.

In aspects, the concentration of impact modifier in the polyamide composition is present in an amount greater than 3 wt %. In some cases, the combination of the impact modifier and the melt stabilizers (optionally in the disclosed amounts and ratios) provides for surprising, synergistic combinations of performance features, e.g., tensile/flexural performance and impact resistance.

The additive of impact modifier is important to the polyamide compositions described herein because the impact modifier, e.g., olefins, acrylates, or acrylics, or combinations thereof, contributes to the mechanical performance, including elongation and impact strength, and reduced modulus of the resultant articles such as extruded article, a profile extrusion article, a monofilament, or a fiber that are desired for automotive and other applications. In contrast, polyamides for film applications do not include impact modifier and are devoid or substantially devoid of impact modifier.

### Other Additives

The polyamide composition can also include one or more chain terminators, viscosity modifiers, plasticizers, UV stabilizers, catalysts, other polymers, flame retardants, delusterants, antimicrobial agents, antistatic agents, optical brighteners, extenders, processing aids, a copper containing compound, and other commonly used additives known to those of skill in the art. Additional suitable additives may be found in Plastics Additives, An A-Z reference, Edited by Geoffrey Pritchard (1998). The optional addition of a stabilizer to the additive dispersion is present in an exemplary embodiment. Stabilizers suitable for the additive dispersion include, but are not limited to, polyethoxylates (such as the polyethoxylated alkyl phenol Triton X-100), polypropoxylates, block copolymeric polyethers, long chain alcohols, polyalcohols, alkyl sulfates, alkyl-sulfonates, alkyl-benzenesulfonates, alkylphosphates, alkyl-phosphonates, alkyl-naphthalene sulfonates, carboxylic acids, and perfluoronates. Particularly, the polyamide compositions herein for non-film applications will comprise an amount of additional additives, which are not typical and not present in a film composition. For example, the polyamide composition may include plasticizer.

The concentration of the plasticizer in the polyamide composition can, for example, range from 0.01 wt % to 10 wt %, e.g., from 0.01 wt % to 0.1 wt %, from 0.05 wt % to 0.2 wt %, from 0.1 wt % to 0.3 wt %, from 0.2 wt % to 0.4 wt %, from 0.3 wt % to 0.5 wt %, from 0.4 wt % to 0.6 wt %, or from 0.5 wt % to 0.7 wt %, from 0.1 to 1.0 wt %, from 0.2 to 2.0 wt %, from 0.3 to 3.0 wt %, from 0.4 to 4.0 wt %, from 0.5 to 5.0 wt %, from 0.6 to 6.0 wt %, from 0.7 to 7.0 wt %, from 0.8 to 8.0 wt %, from 0.9 to 9.0 wt %, from 1.0 to 10 wt %. In terms of upper limits, the plasticizer concentration can be less than 10 wt %, e.g., less than 9.0 wt %, less than 8.0 wt %, less than 7.0 wt %, less than 6.0 wt %, less than 5.0 wt %, less than 4.0 wt %, less than 3.0 wt %, less than 2.0 wt %, less than 1.0 wt %, less than 0.7 wt %, less than 0.6 wt %, less than 0.5 wt %, less than 0.4 wt %, less than 0.3 wt %, less than 0.2 wt %, less than 0.1 wt %, less than 0.05 wt %, less than 0.03 wt %, or less than 0.02 wt %. In terms of lower limits, the plasticizer can be greater than 0.01 wt %, e.g., greater than 0.02 wt %, greater than 0.03 wt %, greater than 0.05 wt %, greater than 0.1 wt %, greater than 0.2 wt %, greater than 0.3 wt %, greater than 0.4 wt %, greater than 0.5 wt %, greater than 0.6 wt %, greater than 0.7 wt %, greater than 0.8 wt %, greater than 0.9 wt %, greater than 1.0 wt %, greater than 2.0 wt %, greater than 3.0 wt %, greater than 4.0 wt %, greater than 5.0 wt %, greater than 6.0 wt %, greater than 7.0 wt %, greater than 8.0 wt %, or greater than 9.0 wt %. Higher concentrations, e.g., greater than 10 wt %, and lower concentrations, e.g., less than 0.01 wt %, are also contemplated. In aspects, the concentration of plasticizer in the polyamide composition is present in an amount greater than 0.1 wt %.

The additive of plasticizer is important to the polyamide compositions described herein because the plasticizer contributes to flow and thermal properties, e.g., decreasing the glass transition temperature (T_{g}), as well as elastic modulus of the resultant articles such as extruded article, a profile extrusion article, a monofilament, or a fiber. In contrast, polyamides for film applications do not include plasticizer and are devoid or substantially devoid of plasticizer.

In some embodiments, the polyamide compositions for non-film applications can comprise an amount of additives, e.g., flow and leveling agents, which are not typical and not present in a film composition. These additives are useful for non-film applications such as powder coating and 3D printing applications.

Additives such as such as primary and/or secondary antioxidants may be included in some glass-filled or impact modified compositions as contemplated herein. Primary antioxidants include hindered phenol, and secondary antioxidants include those that are phosphorous-based. In some embodiments, copper-based heat stabilizers are added depending on the application requirements.

In some embodiments, the stain resistance of the polyamide composition can be improved by salt-blending the polyamide precursor with a cationic dye modifier, such as 5-sulfoisophthalic acid or salts or other derivatives thereof.

Chain extenders can also be included in the polyamide composition. Suitable chain extender compounds include bis-N-acyl bislactam compounds, isophthaloyl bis-caprolactam (IBC), adipoyl bis-caprolactam (ABC), terphthaloyl bis-caprolactam (TBS), and mixtures thereof.

The polyamide composition can also include anti-block agents. Inorganic solids, usually in the form of diatomaceous earth, represent one class of materials that can be added to the disclosed polyamide composition. Non-limiting examples include calcium carbonate, silicon dioxide, magnesium silicate, sodium silicate, aluminum silicate, aluminum potassium silicate, and silicon dioxide are examples of suitable antiblock agents.

The disclosed polyamide compositions can also include a nucleating agent to further improve clarity and oxygen barrier as well as enhance oxygen barrier. Typically, these agents are insoluble, high melting point species that provide a surface for crystallite initiation. By incorporating a nucleating agent, more crystals are initiated, which are smaller in nature. More crystallites or higher % crystallinity correlates to more reinforcement/higher tensile strength and a more tortuous path for oxygen flux (increased barrier); smaller crystallites decreases light scattering which correlates to improved clarity. Non-limiting examples include calcium fluoride, calcium carbonate, talc and Nylon 2,2.

The polyamide compositions can also include organic anti-oxidants in the form of hindered phenols such as, but not limited to, Irganox 1010, Irganox 1076, and Irganox 1098; organic phosphites such as, but not limited to, Irgafos 168 and Ultranox 626; aromatic amines, metal salts from Groups IB, IIB, III, and IV of the periodic table and metal halides of alkali and alkaline earth metals.

Some or all of these components may be considered optional. In some cases, the disclosed compositions may expressly exclude one or more of the aforementioned components, e.g., via claim language. For example claim language may be modified to recite that the disclosed compositions, processes, etc., do not utilize or comprise one or more of the aforementioned additives.

### Mechanical Performance Properties

The polyamide composition can demonstrate a tensile modulus that, for example, ranges from 650 MPa to 2500 MPa, e.g., from 650 MPa to 850 MPa, from 650 MPa to 1050 MPa, from 650 MPa to 1250 MPa, from 650 MPa to 1500 MPa, from 650 MPa to 1750 MPa, from 650 MPa to 1950 MPa, from 650 MPa to 2000 MPa, from 650 MPa to 2250 MPa, from 850 MPa to 1050 MPa, from 850 MPa to 1250 MPa, from 850 MPa to 1500 MPa, from 850 MPa to 1750 MPa, from 850 MPa to 1950 MPa, from 850 MPa to 2000 MPa, from 850 MPa to 2250 MPa, from 850 MPa to 2500 MPa, from 1050 MPa to 1250 MPa, from 1050 MPa to 1500 MPa, from 1050 MPa to 1750 MPa, from 1050 MPa to 1950 MPa, from 1050 MPa to 2000 MPa, from 1050 MPa to 2250 MPa, from 1050 MPa to 2500 MPa, from 1250 MPa to 1500 MPa, from 1250 MPa to 1750 MPa, from 1250 MPa to 1950 MPa, from 1250 MPa to 2000 MPa, from 1250 MPa to 2250 MPa, from 1250 to 2500 MPa, from 1500 MPa to 1750 MPa, from 1500 MPa to 1950 MPa, from 1500 MPa to 2000 MPa, from 1500 MPa to 2250 MPa, from 1500 to 2500 MPa, from 1750 MPa to 1950 MPa, from 1750 MPa to 2000 MPa, from 1750 MPa to 2250 MPa, from 1750 to 2500 MPa, from 2000 MPa to 2250 MPa, from 2000 to 2500 MPa, or from 2250 to 2500 MPa. In terms of upper limits, the tensile modulus can be less than 2500 MPa, e.g., less than 2250 MPa, less than 2000 MPa, less than 1950 MPa, less than 1750 MPa, less than 1500 MPa, less than 1250 MPa, less than 1050 MPa, or less than 850 MPa. In terms of lower limits, the tensile modulus can be greater than 650 MPa, e.g., greater than 850 MPa, greater than 1050 MPa, greater than 1250 MPa, greater than 1500 MPa, greater than 1750 MPa, greater than 1950 MPa, greater than 2000 MPa, or greater than 2250 MPa. Higher tensile moduli, e.g., greater than 2500 MPa, and lower tensile moduli, e.g., less than 650 MPa, are also contemplated. The tensile modulus of the polyamide composition can be measured using a standard protocol such as ISO 527-1 (2019).

The polyamide composition can demonstrate a tensile strength at break that, for example, ranges from 35 MPa to 75 MPa, e.g., from 35 MPa to 45 MPa, from 40 MPa to 50 MPa, from 45 MPa to 55 MPa, from 50 MPa to 60 MPa, from 55 MPa to 65 MPa, from 60 MPa to 70 MPa, or from 65 MPa to 75 MPa. In terms of upper limits, the tensile strength at break can be less than 75 MPa, e.g., less than 70 MPa, less than 65 MPa, less than 60 MPa, less than 55 MPa, less than 50 MPa, less than 45 MPa, or less than 40 MPa. In terms of lower limits, the tensile strength at break can be greater than 35 MPa, e.g., greater than 40 MPa, greater than 45 MPa, greater than 50 MPa, greater than 55 MPa, greater than 60 MPa, greater than 65 MPa, or greater than 70 MPa. Higher tensile strengths, e.g., greater than 75 MPa, and lower tensile strengths, e.g., less than 35 MPa, are also contemplated. The tensile strength at break of the polyamide composition can be measure using a standard protocol such as ISO 527-1 (2019).

The polyamide composition can demonstrate an elongation (tensile) at break that, for example, ranges from 15% to 350%, e.g., from 15% to 35%, from 25% to 45%, from 35% to 55%, from 45% to 65%, from 55% to 75%, from 65% to 85%, from 75% to 95%, from 85% to 105%, from 100% to 150%, from 125% to 175%, from 150% to 200%, from 175% to 225%, from 200% to 250%, from 225% to 275%, from 250% to 300%, from 275% to 325%, or from 300% to 350%. In terms of upper limits, the elongation at break can be less than 350%, e.g., less than 325%, less than 300%, less than 275%, less than 250%, less than 225%, less than 200%, less than 175%, less than 150%, less than 125%, less than 105%, less than 100%, less than 95%, less than 85%, less than 75%, less than 65%, less than 55%, less than 45%, less than 35%, or less than 25. In terms of lower limits, the elongation at break can be greater than 15%, e.g., greater than 25%, greater than 35%, greater than 45%, greater than 55%, greater than 65%, greater than 75%, greater than 85%, greater than 95%, greater than 100%, greater than 105%, greater than 125%, greater than 150%, greater than 175%, greater than 200%, greater than 225%, greater than 250%, greater than 275%, greater than 300%, or greater than 325. Larger elongations, e.g., greater than 350%, and smaller elongations, e.g., less than 15%, are also contemplated. The elongation at break of the polyamide composition can be measured using a standard protocol such as ISO 527-1 (2019).

The polyamide composition can demonstrate a Charpy notched impact energy loss at 23° C. that, for example, ranges from 3 kJ/m² to 17 kJ/m², e.g., from 3 kJ/m² to 5 kJ/m², from 3.5 kJ/m² to 5.5 kJ/m², from 4 kJ/m² to 6 kJ/m², from 4.5 kJ/m² to 6.5 kJ/m², from 5 kJ/m² to 7 kJ/m², from 6 kJ/m² to 8 kJ/m², from 7 kJ/m² to 9 kJ/m², from 8 kJ/m² to 10 kJ/m², from 9 kJ/m² to 11 kJ/m², from 10 kJ/m² to 12 kJ/m², from 11 kJ/m² to 13 kJ/m², from 12 kJ/m² to 14 kJ/m², from 13 kJ/m² to 15 kJ/m², from 14 kJ/m² to 16 kJ/m², or from 15 kJ/m² to 17 kJ/m². In terms of upper limits, the Charpy notched impact energy loss at 23° C. can be less than 17 kJ/m², e.g., less than 16 kJ/m², less than 15 kJ/m², less than 14 kJ/m², less than 13 kJ/m², less than 12 kJ/m², less than 11 kJ/m², less than 10 kJ/m², less than 9 kJ/m², less than 8 kJ/m², less than 7 kJ/m², less than 6 kJ/m², less than 5 kJ/m², less than 4.5 kJ/m², less than 4 kJ/m², or less than 3.5 kJ/m². In terms of lower limits, the Charpy notched impact energy loss at 23° C. can be greater than 3 kJ/m², e.g., greater than 4 kJ/m², greater than 5 kJ/m², greater than 6 kJ/m², greater than 7 kJ/m², greater than 8 kJ/m², greater than 9 kJ/m², greater than 10 kJ/m², greater than 11 kJ/m², greater than 12 kJ/m², greater than 13 kJ/m², greater than 14 kJ/m², greater than 15 kJ/m², or greater than 16 kJ/m². Higher Charpy impact energy losses, e.g., greater than 17 kJ/m², and lower Charpy impact energy losses, e.g., less than 3 kJ/m², are also contemplated. The Charpy notched impact energy loss of the polyamide composition can be measured using a standard protocol such as ISO 179-1 (2010).

The polyamide composition can demonstrate a moisture uptake that, for example, ranges from 0 wt % to 2 wt % moisture at 95% RH, e.g., from 0 wt % to 0.2 wt %, from 0.1 wt % to 0.3 wt %, from 0.2 wt % to 0.4 wt %, from 0.3 wt % to 0.5 wt %, from 0.4 wt % to 0.6 wt %, from 0.5 wt % to 0.7 wt %, from 0.6 wt % to 0.8 wt %, from 0.9 wt % to 1.1 wt %, from 1.0 wt % to 1.2 wt %, from 1.1 wt % to 1.3 wt %, from 1.2 wt % to 1.4 wt %, from 1.3 wt % to 1.5 wt %, from 1.4 wt % to 1.6 wt %, from 1.5 wt % to 1.7 wt %, from 1.6 wt % to 1.8 wt %, from 1.7 wt % to 1.9 wt %, or from 1.8 wt % to 2.0 wt %. In terms of upper limits, the moisture uptake can be less than 2.0 wt % moisture at 95% RH, e.g., less than 1.9 wt %, less than 1.8 wt %, less than 1.7 wt %, less than 1.6 wt %, less than 1.5 wt %, less than 1.4 wt %, less than 1.3 wt %, less than 1.2 wt %, less than 1.1 wt %, less than 1.0 wt %, less than 0.9 wt %, less than 0.8 wt %, less than 0.7 wt %, less than 0.6 wt %, less than 0.5 wt %, less than 0.4 wt %, less than 0.3 wt %, less than 0.2 wt %, or less than 0.1 wt %. In terms of lower limits, the moisture uptake can be greater than 0% moisture at 95% RH, e.g., greater than 0.1 wt %, greater than 0.2 wt %, greater than 0.3 wt %, greater than 0.4 wt %, greater than 0.5 wt %, greater than 0.6 wt %, greater than 0.7 wt %, greater than 0.8 wt %, greater than 0.9 wt %, greater than 1.0 wt %, greater than 1.1 wt %, greater than 1.2 wt %, greater than 1.3 wt %, greater than 1.4 wt %, greater than 1.5 wt %, greater than 1.6 wt %, greater than 1.7 wt %, greater than 1.8 wt %, or greater than 1.9 wt %. Larger moisture uptakes, e.g., greater than 2.0 wt % moisture at 95% RH are also contemplated. The moisture uptake of the polyamide composition can be measured using a standard protocol such as ISO 62:2008 for measuring moisture uptake of pellets or parts under a controlled environment.

The polyamide composition can demonstrate a chemical resistance that, for example, resists various acids, bases, solvents, etc. by assessing swelling, dissolution, weight loss, and other properties. The polyamide composition can demonstrate an abrasion resistance that, for example, demonstrates an abrasion resistance greater than or equal to that of PA6,12 and/or PA12.

### Preferred Compositions

In one embodiment, the polyamide composition comprises PA6,12, the dimer modifier is dimer amine present in an amount ranging from 15 wt % to 50 wt %, wherein the polyamide composition demonstrates a tensile elongation of at least 50%, a chemical resistance for example as measured by exposure to HCl (10%) for 14 days at 58° C., resulting in a weight loss of less than 0.8 wt %, and a moisture uptake of less than about 2.0 wt % moisture at 95% RH. The PA6,12 can be present in an amount ranging from 50 wt % to 85 wt %.

In one embodiment, the polyamide polymer composition comprises PA6,12, the dimer modifier is dimer acid present in an amount ranging from 15 wt % to 50 wt %, wherein the polyamide composition demonstrates a tensile elongation of at least 20%, a chemical resistance for example as measured by exposure to HCl (10%) for 14 days at 58° C., resulting in a weight loss of less than 0.8 wt %, and a moisture uptake of less than about 2.0 wt % moisture at 95% RH. The PA6,12 can be present in an amount ranging from 50 wt % to 85 wt %.

In one embodiment, the polyamide polymer composition comprises PA6,12, the dimer modifier is dimer amine present in an amount ranging from 35 wt % to 55 wt %, wherein the polyamide composition demonstrates a notched Charpy impact energy loss at 23° C. that is greater than 4.5 kJ/m², a chemical resistance for example as measured by exposure to HCl (10%) for 14 days at 58° C., resulting in a weight loss of less than 2.8 wt %, and a moisture uptake of less than about 2.0 wt % moisture at 95% RH. The PA6,12 can be present in an amount ranging from 45 wt % to 65 wt %.

In one embodiment, the polyamide polymer composition comprises PA6,12, the dimer modifier is in an amount of about 20 wt %, wherein the polyamide composition demonstrates a notched Charpy impact energy loss at 23° C. that is greater than 3.5 kJ/m², a tensile strength greater than 50 MPa, a tensile modulus greater than 1950 MPa, a chemical resistance for example as measured by exposure to HCl (10%) for 14 days at 58° C., resulting in a weight loss of less than 2.8 wt %, and a moisture uptake of less than about 2.0 wt % moisture at 95% RH. The PA6,12 can be present in an amount of about 80 wt %.

### Methods of Preparation

The present disclosure also relates to processes of producing the provided polyamide compositions. The methods include providing one or more polyamide polymers, a modifier comprising a dimer acid or a dimer amine or a combination thereof, and optionally glass fibers, mineral fillers, impact modifiers, and one or more heat stabilizers or other additives. The methods can further include selecting the type and relative amounts of the one or more polyamide polymers and the modifier comprising a dimer acid or a dimer amine or a combination thereof to provide desired chemical resistance, reduced water uptake, and mechanical properties to the resulting polyamide composition. The methods further include combining the one or more polyamide polymers and the modifier comprising a dimer acid or a dimer amine or a combination thereof to produce the polyamide composition. In some embodiments, the methods further include selecting, providing, and/or combining one or more dyes such as nigrosine, one or more pigments such as carbon black, one or more mineral fillers, and/or one or more melt stabilizers/lubricants.

The components of the polyamide composition can be mixed and blended together to produce the polyamide composition, or can be formed in situ using appropriate reactants. The terms “adding” or “combining” without further clarification are intended to encompass either the addition of the material itself to the composition or the in situ formation of the material in the composition. In some embodiments, the polyamide composition is prepared using a high solids approach from individual components rather than from individual aqueous based salts. The solids content of the first solution containing the polymer components is greater than 80%. The solution may then evaporated an evaporator. The modifier can bypass the evaporator and then be added to form a single mixture. The modifier comprises a dimer acid or a dimer amine or a combination thereof, wherein the modifier includes from 18 to 44 carbon atoms. The high solids method is advantageous when employing hydrogenated dimer materials, e.g., hydrogenated dimer acid or hydrogenated dimer amine, which are highly hydrophobic.

In other embodiments, suitable for pilot, scale-up, or commercial operations, water soluble nylon salts (e.g., PA6,6, PA6,10, PA6,12, and others) are processed through an evaporation step to increase the solids content from a starting range of 40 wt % to 50 wt % up to a range of 75 wt % to 90 wt %. After evaporation, the salt is then pumped into a reaction vessel and combined with the hydrogenated modifier, e.g. hydrogenated dimer acid or hydrogenated dimer amine. Temperatures in the vessel are then elevated to a temperature ranging from 220° C. to 270° C. under pressures ranging from 185 psia to 270 psia. Pressure is then reduced to atmospheric over a period of 30 min to 90 min while temperature is maintained between 250° C. and 270° C. After the pressure reaches atmospheric, finishing is then performed either at atmospheric pressure or under vacuum. Pressures range from 2 psia to 10 psia when vacuum is applied. Finishing times can range between 10 minutes and 60 minutes depending on the desired viscosity/molecular weight. After finishing, nitrogen head pressure is applied and the molten polymer is extruded through a circular die, submersed under water in a strand tray, and sent to a strand pelletizer. After pelletizing, surface moisture is removed from the pellets from residual heat and air from a spin dryer; pellets are collected in a foil-lined container.

In another embodiment, two or more materials to be combined with the composition are simultaneously added via masterbatch.

### Molded Articles

The present disclosure also relates to articles that include any of the provided polyamide compositions. The article can be produced, for example, via conventional injection molding, extrusion molding, blow molding, press molding, compression molding, or gas assist molding techniques. Molding processes suitable for use with the disclosed compositions and articles are described in U.S. Pat. Nos. 8,658,757; 4,707,513; 7,858,172; and 8,192,664, each of which is incorporated herein by reference in its entirety for all purposes. Examples of articles that can be made with the provided polyamide compositions include those used in electrical and electronic applications (such as, but not limited to, circuit breakers, terminal blocks, connectors and the like), automotive applications (such as, but not limited to, air handling systems, radiator end tanks, fans, shrouds, and the like), furniture and appliance parts, and wire positioning devices such as cable ties.

In some embodiments, an injection molded article comprising any of the provided polyamide compositions is provided. In other embodiments, an extruded article of any of the provided polyamide compositions is provided and can be a profile extrusion article, a monofilament, or a fiber.

### EXAMPLES

Examples 1-8 were prepared using the formulations listed in Table 2. Table 1 shows dimer acid/amine content for Examples 1-8, as well as additional Examples 9-11, in terms of the total repeat unit molecular weights based on dimer acid or dimer amine. For example, Ex. 1 had 20 wt % dimer acid repeat units and Ex. 5 had 10 wt % dimer acid repeat units and 10 wt % dimer amine repeat units. Examples 1-11 each have an Mₙ less than 30,000 g/mol.

TABLE 1
Examples for PA6, 12 reacted with a Dimer Modifier

| | | | | Ex. 4/ | | | | | | | |
|---|---|---|---|---|---|---|---|---|---|---|---|
| | Ex. 1 | Ex. 2 | Ex. 3 | Ex. 4A | Ex. 5 | Ex. 6 | Ex. 7 | Ex. 8 | Ex. 9 | Ex. 10 | Ex. 11 |
| Modifier | Repeat Unit MW | | | | | | | | | | |
| % Dimer Acid | 20 | 45 | — | — | 10 | 20 | 30 | 30 | 15 | 35 | — |
| % Dimer | — | — | 20 | 45 | 10 | 15 | 15 | 15 | — | — | 35 |
| Amine | | | | | | | | | | | |

Examples 1-8 were prepared by combining components, as shown in Table 2 and compounding the mixture using a polymerization process in an autoclave, where the components were charged to a reactor. Components were selected from the following with molecular weight as indicated in parentheses and source if applicable: PA6,12 (100% solids, MW 346.5), hexamethylene diamine (50% aq, MW 116), dodecanedioic acid (MW 230, Acme Hardesty), dimer acid (MW 570, Pripol 1009, Croda), dimer diamine (MW 540, Priamine 1075, Croda), adipic acid (MW 146), phenolic antioxidant stabilizer (MW 531, Irganox® 1098, Sigma Aldrich), and sodium hypophosphite (2 wt %) (MW 88). Additives were added to the melt. Target per batch was 500 grams of solids. Example compositions were heated to 140° C. to 160° C. before stirring was initiated at pressures of 20 psia to 45 psia. Upon stirring and an initial evaporation observed, the reactor vessel was then pressurized to 200 psia to 265 psia. Pressures of 20 psia to 45 psia were maintained until temperatures of 220° C. to 250° C. were reached, at which time the pressures were then reduced over a time period of 30 min±10%. Temperatures were between 245° C. to 265° C. as pressure reached atmospheric conditions. After reaching atmospheric pressure, vacuum was applied for 30 min±10% after which pressures were maintained at 5 psia±10%. Strands were then extruded over a period of 10 min to 30 min and pelletized into a container under a nitrogen (N₂) blanket.

All copolymer formulations were successfully made from individual components (rather than from aqueous based salts as with the pilot, scale-up, or commercial operation processes described above). This high solids method is important because hydrogenated dimer materials are highly hydrophobic. Therefore, large amounts of water present in the initial recipe, as in formulations relying on aqueous based salts, would result in a non-homogenous mixture that compromises processing, particularly in the evaporation and pressure steps. In addition, agitation is avoided until the mixture temperature reaches 140° C., which is above the melting point of dodecanedioic acid. Once this temperature is met, the dodecanedioic acid solvates the C36 monomer and results in a homogenous reactive mixture of diamines, diacids, and additives. The process employed is highly repeatable, as illustrated in the data (e.g., melt points as in Table 8). Moreover, the high solids method proves a robust method for various levels of C36 modification in the range of the dimer acid and/or dimer amine modification as described herein.

TABLE 2
Example Compositions

| | Ex. 1 | Ex. 2 | Ex. 3 | Ex. 4 | Ex. 4A | Ex. 5 | Ex. 6 | Ex. 7 | Ex. 8 |
|---|---|---|---|---|---|---|---|---|---|
| Component | Wt % | | | | | | | | |
| Hexamethylene | 46.8 | 41.8 | 42.9 | 32.1 | 30.7 | 44.8 | 40.1 | 38.7 | 38.2 |
| Diamine (50% | | | | | | | | | |
| aq) | | | | | | | | | |
| Dodecanedioic | 41.0 | 29.5 | 42.1 | 31.3 | 41.7 | 41.6 | 35.0 | 30.1 | 33.6 |
| Acid | | | | | | | | | |
| Dimer Acid | 12.1 | 28.6 | — | — | — | 6.1 | 12.6 | 19.4 | 19.1 |
| Dimer Diamine | — | — | 11.8 | 28.7 | 27.5 | 5.8 | 9.0 | 9.2 | 9.1 |
| Adipic Acid | — | — | 3.2 | 7.8 | — | 1.6 | 2.4 | 2.5 | — |
| Phenolic | 0.08 | 0.09 | 0.09 | 0.09 | 0.09 | 0.08 | 0.09 | 0.09 | 0.09 |
| Antioxidant | | | | | | | | | |
| Stabilizer | | | | | | | | | |
| Sodium | 0.01 | 0.01 | 0.01 | 0.01 | 0.01 | 0.01 | 0.01 | 0.01 | 0.01 |
| Hypophosphite | | | | | | | | | |

As noted above the percentage of dimer acid and/or dimer amine for Examples 1-8 in Table 1 represent the total repeat unit molecular weights based on dimer acid or dimer amine. Actual amounts of pure dimer acid and/or dimer amine that were used in production of the respective polyamide were lower. For example, at 20% dimer acid repeat units for Ex. 1 and 45% dimer acid repeat units for Ex. 2, the actual percentages dimer acid used in production are about 12.1 wt % and about 28.6 wt %, respectively, of the polymer as shown in Table 2. Ex. 4A has the same percentage dimer acid as Ex. 4, differing in that no adipic acid was used in the formulation of Ex. 4A. Similarly, Ex. 8 has the same percentage dimer acid and dimer amine as Ex. 7, differing in that no adipic acid was used in the formulation of Ex. 7A. Properties of the polyamide may be tailored by varying the amounts of dimer acid and/or dimer amine incorporated into the polyamide. By incorporating more dimer acid and/or dimer amine, for example, a more flexible material (having a lower modulus) with greater toughness, the material having enhanced impact resilience and elongation to break, may be realized.

As shown in Tables 3 through 5, dimer acids and/or dimer diamines were reacted into PA6,12 to provide for properties such as tensile strength, modulus, elongation, impact strength, chemical resistance, and moisture absorption, thus yielding hybrid systems with a balance of properties. Unmodified PA6,12 and unmodified PA12 are provided as Comparative examples. This approach is believed to produce hybrid systems with properties correlating with the spectrum of properties falling between the properties of PA6,12 and PA12.

Comparative examples include Comparative Example A (PA6,12 without dimer content) and Comparative Example B (PA12 without dimer content).

Examples 9-11 were also prepared in a similar manner as for the formulations of Examples 1-8 as in Table 2 by reacting dimer modifier into PA6,12 to provide the respective Example. Ex. 9 included 15 wt % dimer acid repeat units, Ex. 10 included 35 wt % dimer acid repeat units, and Ex. 11 included 35 wt % dimer amine repeat units.

Table 3 shows a comparison of Ex. 2 including 45 wt % dimer acid and Ex. 9 including 15 wt % dimer acid versus Comparative Ex. B. The equilibrium moisture absorption @ 23° C. and 50% RH of Ex. 2 is comparable to that the Comparative Ex. B (unmodified PA12) and advantageously Ex. 2 has a higher melting point than the unmodified PA12 polyamide. As also shown in Table 3, the tensile strength and tensile modulus of Ex. 9 including 15 wt % dimer acid is greater than that of Comparative Ex. B (unmodified PA12), and Ex. 9 advantageously also has a higher melting temperature than the unmodified PA12 polyamide.

TABLE 3
Examples (45% and 15% Dimer Acid) and Comparative Properties

| | Tensile | Tensile | Melting | Moisture |
|---|---|---|---|---|
| | Strength | Modulus | Point, Tₘ | Absorption (%) |
| Example | (MPa) | (MPa) | (° C.) | @ 23° C. and 50% RH |
| Ex. 2 | 41.85 | 888.2 | 201 | 0.4 |
| Ex. 9 | 52.84 | 2178 | 213 | — |
| Comp. Ex. B | 50 | 1500 | 178 | 0.4 |

Referring to Table 4, data for tensile strength, tensile modulus, elongation, impact strength, and melting point are provided for Examples 1-4, 10, and 11, as well as for Comparative Examples A and B.

TABLE 4
Examples and Comparative Properties Summary

| | Average | Average | | Average | |
|---|---|---|---|---|---|
| | Tensile | Tensile | | Impact | |
| | Strength | Modulus | Elongation | Strength | Tₘ |
| Example | (MPa) | (MPa) | (%) | (KJ/m²) | (° C.) |
| Comp. Ex. A | 59.4 | 2062.3 | 12.8 | 3.6 | 217 |
| Comp. Ex. B | 51.1 | 1706.3 | 107.0 | 2.9 | 217 |
| Ex. 1 | 57.0 | 2210.3 | 18.6 | 4.1 | 211 |
| Ex. 2 | 44.9 | 1009.0 | 47.2 | 4.1 | 201 |
| Ex. 3 | 51.4 | 1954.0 | 66.5 | 3.6 | 184 |
| Ex. 4 | 32.1 | 679.0 | 305.0 | 14.3 | 173 |
| Ex. 10 | 51.3 | 1842.7 | 30.9 | 4.9 | 205 |
| Ex. 11 | 34.5 | 1107.7 | 75.0 | 4.6 | 181 |

As shown on Table 4, Ex. 1 demonstrated a tensile strength similar to that of Comparative Ex. A. Advantageously, enhanced chemical and moisture resistance was also observed during testing, see discussion below. Ex. 10 produced a material with similar tensile strength as that of Comp. Ex. B, with the added benefit of enhanced temperature resistance. Dimer acid modification affected the tensile strength less than dimer amine modification. It is believed that dimer amine distributes more evenly within the polymer chain thereby affecting the crystallinity and hence the tensile strength.

As also shown in Table 4, the tensile modulus and elongation measurements of Examples 1-4, 10 and 11 can be tailored between about 650 MPa and about 2200 MPa for tensile modulus and between about 15% and 100% (or up to 300% or more) directly out of the reactor by modifying the backbone. Stated another way, the dimer content can be used as a compositional variable to tune performance to a desired result. Advantageously, Ex. 4 was found to be very flexible with a tensile modulus of about 650 MPa and should also meet the modulus requirements for plasticized or toughened PA6,12 applications. Example 4 also demonstrates an impact resilience and elongation superior to PA12.

Tensile elongation requirements may also be tailored by adjusting the type of comonomer and the amount of dimer modifier. In some cases, dimer amine more significantly affects tensile modulus and elongation than dimer acid. It is believed that dimer amine has a more significant effect on elongation due to the even distribution affecting the crystallinity.

Referring again to Table 4, polyamide composition samples including dimer acid and/or dimer amine demonstrate greater impact strength than Comparative Examples A and B. Ex. 4 is particularly good and shows an impact strength even better than other working examples, e.g., at least 3 times Examples 1, 2, 3, 10, and 11 and better than Comparative Examples A and B.

Chemical resistance data are summarized in Table 5 for Examples 1-4 having dimer repeat units incorporated as described above. Chemical resistance can be determined by evaluating the weight gain/loss of various formulations after exposure to a variety of acids, bases, and solvents. Comparative Ex. A and Comparative Ex. B were used as comparatives; the unmodified PA12 reference material was Grilamid L 25A NZ (EMS-GRIVORY). The Chemical Reagent test included exposing Examples 1-4, and Comparative Ex. A and Comparative Ex. B, to each of the following chemical reagents: HCl (10%) for 14 days at 58° C.; H₂SO₄ (38%) for 1 day at room temperature; and methanol for 7 days at room temperature.

Data in Table 5 indicate the percentage weight loss resulting from the timed exposures, with lesser weight loss indicating greater chemical resistivity. The weight loss for each of Examples 1-4 is less than that of the weight loss for Comparative Ex. B for the HCL (10%) exposure for 14 days at 58° C. indicating superior chemical resistance. Ex. 1 and Ex. 2 showed particularly improved resistance to the HCl exposure even when compared with the Ex. 3 and Ex. 4, which incorporated dimer amine. The polyamides of Examples 1-4 are generally incompatible with exposure to H₂SO₄ (38%) for 1 day at room temperature, meaning that the media swells, attacks, or dissolves the sample polyamide. The data of Table 5 further indicate that Examples 1-4 have as good or better chemical resistance to methanol as compared to Comparative Ex. B.

TABLE 5
Chemical Resistance Comparison Data

| | Chemical Reagent and Test Condition | | |
|---|---|---|---|
| | HCl (10%) | H₂SO₄ (38%) | Methanol |
| Example | 14 days at 58° C. | 1 day at RT | 7 days at RT |
| Ex. 1 | 0.7 wt % | incompatible | 1.9 wt % |
| Ex. 2 | 0.1 wt % | incompatible | 1.7 wt % |
| Ex. 3 | 2.7 wt % | incompatible | 1.9 wt % |
| Ex. 4 | 2.2 wt % | incompatible | 1.5 wt % |
| Comparative Ex. A | No data | incompatible | No data |
| Comparative Ex. B | 3.1 wt % | incompatible | 1.9 wt % |

Referring to Table 6, PA6,6 was reacted with a modifier comprising a dimer acid and/or a dimer amine to provide Ex. 12 including 10 wt % dimer acid repeat units, Ex. 13 including 20 wt % dimer acid repeat units, and Ex. 14 including 20 wt % dimer amine repeat units. The dimer incorporation into PA6,6 was observed to provide improved toughness and chemical resistance while maintaining thermal characteristics.

TABLE 6
Thermal Characteristics for Example and
Comparative Example Compositions

| | | Crystallization | | |
|---|---|---|---|---|
| | Tₘ | Temperature | Relative | NH₂ |
| Example | (° C.) | (° C.) | Viscosity | (microeq/g) |
| Ex. 12 | 261 | 210 | 70 | 42 |
| Ex. 13 | 261 | — | — | 40 |
| Ex. 14 | 261 | 206 | — | 60 |

A summary of property data is shown in Table 7 for Ex. 1 and Ex. 4. Also shown in Table 7 are data for Comparative Ex. A and Comparative Ex. B. Results demonstrate that the disclosed polyamide compositions may be modified to incorporate dimer acid or dimer amine, and combinations thereof, at different amounts in order to tailor mechanical properties with an increase in chemical resistance while reducing moisture uptake. Ex. 1 provides similar thermal and mechanical properties as for unmodified PA6,12 and may be suitable for applications requiring high strength, stiffness, and temperature resistance with additional benefits of reduced moisture uptake and improved chemical resistance. Modifying PA6,12, for example, with dimer amine (Ex. 4) provides enhanced softness/flexibility and may be suitable for a wide variety of applications requiring high flexibility and toughness, e.g., for tubing, powder coatings, and the like.

TABLE 7
Polyamide Comparison Summary of Properties

| | | Comp. | Comp. | | |
|---|---|---|---|---|---|
| Property | Units | Ex. A | Ex. B | Ex. 1 | Ex. 4 |
| Tensile Strength | MPa | 55 | 50 | 55 | 35 |
| Tensile Modulus | MPa | 2200 | 1400 | 2200 | 700 |
| Elongation @ | % | 30-100 | 50-150 | >50 | 200-350 |
| Break | | | | | |
| Notched Charpy | KJ/m² | 5 | 5 | 5 | 14 |
| Impact Strength | | | | | |
| Tₘ | ° C. | 215 | 178 | 211 | 175 |
| DTUL-0.45 Mpa | ° C. | 150 | 120 | — | — |
| Moisture Uptake | % | 1 | 0.5 | 0.5 | 0.5 |
| Chemical | N/A | Good | Excellent | Good/ | Excellent |
| Resistance | | | | Excellent | |
| Density | g/cc | 1.06 | 1.01 | 1.04 | 1.00 |

Examples 1-8 then underwent thermal analyses for thermal, as well as moisture uptake analyses and table abrasion.

Pellets produced from 2 L clave were thermally analyzed for Tₘ (MTPT) and T_{c} (REXC). Samples produced from compression molding were used for dynamic mechanical analysis (DMA) using a TA Q800 DMA, performed in tensile mode at 1 Hz frequency for a temperature sweep of 50° C. to 200° C. at a ramp rate of 3° C./min.

Tensile properties, according to ISO 527-2, and notched Charpy impact, according to ISO 179/1eA, were analyzed using bars made from compression molding.

Moisture uptake analysis was performed on the samples. The analysis was performed using a Vapor Sorption Analysis instrument, TA Instruments. Maximum moisture uptake was measured at 23° C., 50% RH and 23° C., 95% RH.

Taber abrasion analysis was performed on 3 mm thick sheets made from compression molding. Testing was conducted using a 5130 Abraser and CS-17 Calibrase wheels attached to a vacuum for vacuum sealing. Samples were prepared by wiping clean with isopropyl alcohol and were conditioned at 50%+10% humidity and 23° C.+2° C. for 40 hours before being weighed on a balance in this humidity and temperature-controlled environment. Samples were stored in this environment before and after testing. Before testing and consequently after every sample tested, wheels were conditioned using Abraser Refacing Discs. The discs were loaded and ran for 50 cycles. Once completed, refacing discs were discarded, and remnants of wheel refacing were vacuumed prior to sample loading. Samples ran for 1000 revolutions with 1 kg weight. Samples were left in a humidity and temperature-controlled environment for a minimum of 40 hours before being re-weighed for weight loss measurements.

TABLE 8
Melt Point determined by Thermal Analyses

| | | | | | Ex. 4A | | | | Ex. 8 |
|---|---|---|---|---|---|---|---|---|---|
| | Ex. 1 | Ex. 2 | Ex. 3 | Ex. 4 | (No adipic) | Ex. 5 | Ex. 6 | Ex. 7 | (No adipic) |
| Sample # | Melt Pont (° C.) | | | | | | | | |
| Sample 1 | 213 | 200 | 200 | 172 | 205 | 197 | 192 | 200 | 196 |
| Sample 2 | 213 | 200 | 199 | 174 | — | — | — | — | 196 |
| Sample 3 | 213 | 200 | 200 | 175 | — | — | — | — | 194 |
| Sample 4 | — | — | 200 | — | — | | | | |
| Average | 213 | 200 | 200 | 174 | 205 | 197 | 192 | 200 | 195 |

For Examples 1-4 and 8 of Table 8, data was collected on multiple samples as indicated. As shown in Table 8, Examples 1-8 had melt points ranging from 172° C.-213° C., which correspond closely to the lower and upper points of unmodified PA12 and PA6,12, respectively. It was observed that with increased additions of hydrogenated dimer acid or hydrogenated dimer amine, the melting point decreases. Further, systems with hydrogenated dimer amine have a more exaggerated decrease in melting point than with dimer acid. Extrusion pressures were in line with standard viscosity (e.g., VNs ˜110-130 mL/g) of PA6,12 homopolymers, therefore, desired molecular weights were achieved.

The impact of melting point for C₃₆ diacid and C₃₆ diamine is evident from the results as shown in Table 8. The C₃₆ diacid maintains melt points equal to or greater than 200° C., even at 45% incorporation of % dimer acid as shown by Example 2. At this point, the methyl to amide ratio substantially matches PA12 yet Example 2 has a melting point that is approximately 25° C. greater than that of PA12. Further, dimer amine modifications were performed with and without adipic acid stoichiometric balancing as in Examples 4 and 4A, respectively. With adipic acid to balance out the C36 diamine functionality as with Example 4, much lower melting points with an average of 174° C. were measured as compared with when the C36 diamine was simply balanced with additional dodecanedioic acid as with Example 4A. The reason this difference is seen is increased complexity of the backbone when adding adipic to the system; in this case, two diamines (HMD and C36 diamine) and two diacids (adipic acid and dodecanedioic acid) are present. It is believed that this equates to four monomers being present, and results in four potential repeat units (6,12; 6,36; 36,6; and 36,12), hence, a tetrapolymer is formed. This complexity of the backbone prevents crystallinity more than a system with two possible repeat units (e.g., Example 4 including 6,12 and 36,12 repeat units possible).

TABLE 9
Thermal Transition Temperatures

| Example | T_{g} (° C.) | Tₘ (° C.) | T_{c} (° C.) | Tₘ − T_{c} (° C.) |
|---|---|---|---|---|
| Comp. Ex. A | 59 | 217 | 176 | 41 |
| Ex. 1-A | 57 | 213 | 174 | 39 |
| Ex. 2-A | 36 | 200 | 145 | 55 |
| Ex. 3-A | 49 | 200 | 140 | 60 |
| Ex. 4-A | 28 | 174 | 90 | 84 |
| Comp. Ex. B | 50 | 178 | 152 | 26 |

As shown in Table 9, the copolymers can be tailored to have Tₘ or T_{g} in a range from between 170° C. to 220° C. (e.g., a continuum of melting points between PA12 and PA6,12) and 25° C.-60° C. respectively based on the dimer monomer type and dimer monomer concentration in the final polymer. Also, the crystallization temperature can be significantly altered based on the dimer monomer type and concentration. High concentrations of dimer acid or dimer amine in the polymer showed remarkably low T_{c} values, which translates to slower crystallization rates, an advantageous feature for applications such as powder coating and 3D printing. Notably, the PA6,12+20% dimer acid formulation of Example 1 had similar Tₘ and T_{c} as for PA6,12 (Comp. Ex. A). Therefore, the formulation of Example 1 will process very similarly for injection molding as would PA6,12. For example, the formulation of Example 1 would have similar processing conditions and cycle times, while having property advantages such as improved moisture and chemical resistance as compared with PA6,12.

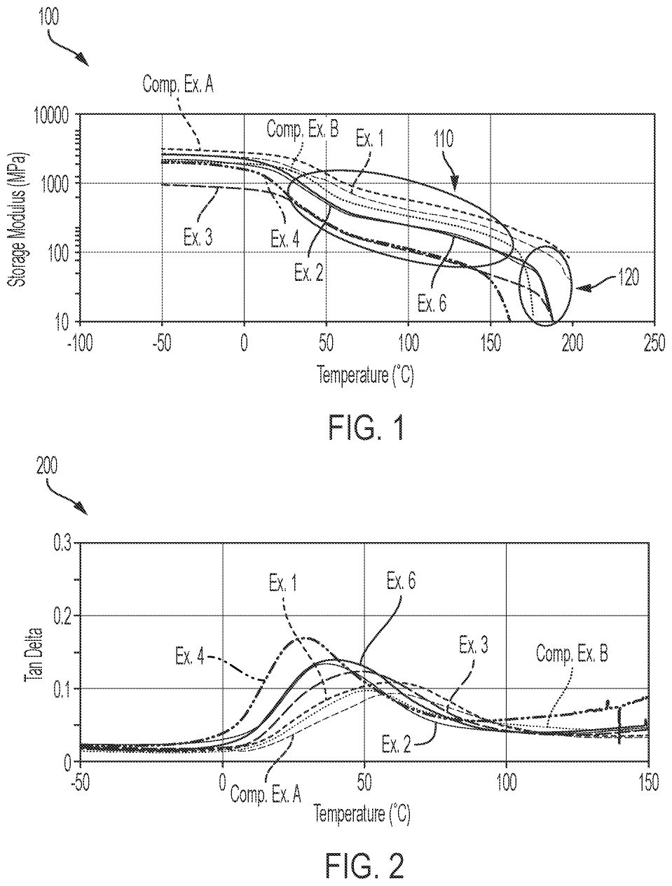

FIG. 1 illustrates the storage modulus as a function of temperature as obtained from DMA analysis. Plot 100 shows the copolymer compositions of Examples 1, 2, 3, 4, and 6 as compared with Comp. Ex. A (PA6,12) and Comp. Ex. B (PA12). These data demonstrate storage modulus can be tailored to match or outperform that of monomers PA6,12 or PA12. Higher amounts of dimer acid or dimer amine resulted in polymers with lower storage modulus across the temperature range from −50 to 150° C., designated element 110, as shown by Examples 2 and 4 as compared to Comp. Ex. A (PA6,12) and Comp. Ex. B (PA12). At elevated temperature (e.g., above 150° C. as designated by element 120), Examples 1, 2, 3, and 6 hold up higher storage modulus as compared with Comp. Ex. B (PA12), which is believed to translate to higher service or use temperatures for the copolymers as compared to PA12.

Further depicted using DMA analysis is the glass transition T_{g}, behavior, shown as the peak in Tan Delta as a function of temperature as illustrated in FIG. 2 in plot 200. The Examples 1, 2, 3, 4, and 6 show broader alpha transitions (glass transitions) and higher peak intensities compared to Comp. Ex. A (PA6,12) and Comp. Ex. B (PA12), thus demonstrating that Examples 1, 2, 3, 4, and 6 have enhanced dampening characteristics and toughness.

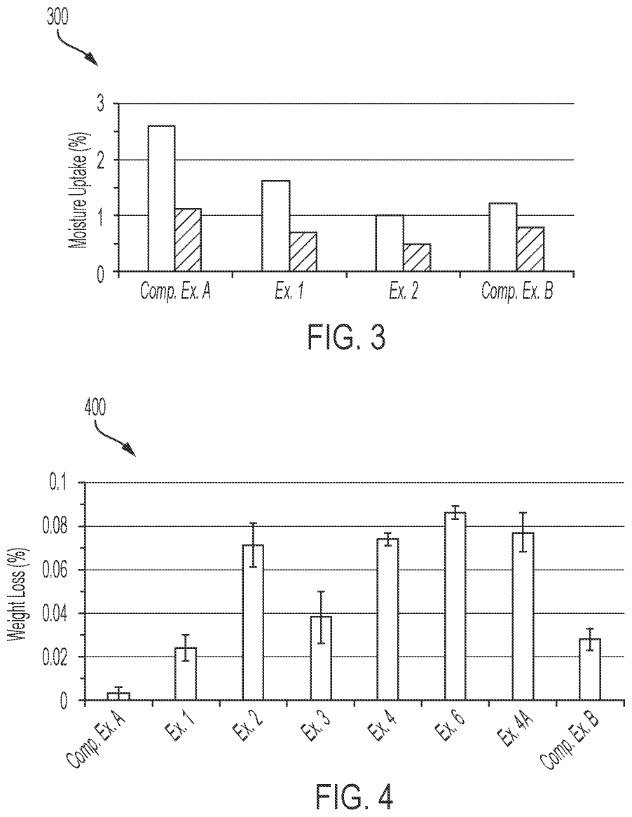

Moisture uptake results are shown in FIG. 3 and in Table 10. Graph 300 shows the moisture uptake of Examples 1 and 2 and Comp. Ex. A (PA6,12) and Comp. Ex. B (PA12) at 23° C. and 95% RH (represented by the patterned bars), 23° C. and 50% RH (represented by the solid bars). Table 10 shows the data numerically for the same data set. FIG. 3 and Table 10 show the excellent moisture resistance exemplified in Examples 1 and 2. At 20% addition of dimer acid to PA6,12, as in Ex. 1, results demonstrate copolymers that show equivalent moisture resistance as that of PA12. It is believed that the dimer phases of the copolymers may come to the skin (or toward the surface) of the molded articles, and that the hydrophobicity of the dimer phases is then providing the copolymers their excellent moisture barrier. Further, at equivalent methyl/amide ratio as for Comp. Ex. B (PA12) as compared with Ex. 2, Ex. 2 exhibits an even lower moisture uptake. This property is attractive for many applications requiring high dimensional stability and moisture inertness to mechanical properties, such as but not limited to flexible tubing, natural gas piping, and powder coatings.

TABLE 10
Moisture Uptake

| | Moisture Uptake | Moisture Uptake |
|---|---|---|
| Example | 95% RH | 50% RH |
| Comp. Ex. A | 2.6 | 1.1 |
| Comp. Ex. B | 1.2 | 0.8 |
| Ex. 1 | 1.6 | 0.7 |
| Ex. 2 | 1.0 | 0.5 |

FIG. 4 shows that samples analyzed by Taber test all showed good abrasion resistance, e.g., less than 0.1% weight loss. Abrasion resistance correlates with the percentage crystallinity of the material, where the higher the crystallinity, the better the abrasion resistance. Comp. Ex. A (PA6,12) demonstrated the best abrasion resistance (lowest % weight loss) because of its highest percentage crystallinity. And Ex. 1, with 20% dimer acid incorporation showed slightly better abrasion resistance as that of Comp. Ex. B (PA12). Advantageously, the Taber test showed that all of the polyamides tested demonstrate high abrasion resistance, resulting in weight losses of less than 1000 ppm, and notably the Taber test used herein employed one of the most abrasive Calibrase wheels within Taber abrasion testing. It is contemplated that further optimization through additives will reduce the coefficient of friction and/or increased molecular weight.

Chemical resistance was measured comparatively to different reagents as summarized in Table 11. Results demonstrated that higher levels of dimer acid or amine modification results in solid performance to acids, bases, salts, and polar (methanol) and non-polar (hexane) solvents. Specifically, Ex. 2 with 45% dimer acid incorporation performed very well in HCl, NAOH, and ZnCl₂ and clearly outperformed PA12 in acid resistance, whereas, Ex. 4 with 45% dimer amine incorporation had good resistance to reagents but performed best in NAOH. Both Examples 2 and 4 performed better in NAOH and ZnCl₂ as compared to Comp. Ex. A (PA6,12). Further, examples having higher dimer acid or dimer amine content performed with better resistance to hydrocarbon solvents (hexane) than the comparatives Comp. Ex. A or Comp. Ex. B.

TABLE 11
Chemical Resistance

| | Weight loss (%) | | | | |
|---|---|---|---|---|---|
| | 10% HCl | 35% NaOH | Methanol | Hexane | 50% ZnCl₂ |
| Sample | 2 weeks @ 58° C. | 3 days @ RT | 1 week @ RT | 3 days @ RT | 3 days @ RT |
| Ex. 1 | 0.66 | 1.04 | 1.95 | 1.11 | 2.27 |
| Ex. 2 | 0.14 | 1.46 | 1.74 | 0.52 | 0.33 |
| Ex. 3 | 2.74 | 4.83 | 1.94 | 1.01 | 3.43 |
| Ex. 4 | 2.18 | 0.41 | 1.5 | 1.6 | 0.48 |
| Comp. Ex. A | 0.16 | 4.61 | 0.2 | 1.6 | 2.0 |
| Comp. Ex. B | 3.15 | 1.04 | 1.9 | 1.09 | 0.54 |

As described herein, modification with dimer acid and/or dimer amine provides beneficial properties tailorable to a wide range of applications. Referring to Tables 4 and 7, mechanical properties are also highly tailorable with the additions of dimer acids and/or dimer amines. For example, tensile modulus can be tailored from ˜700 MPa to ˜2200 MPa (as shown on Table 4) without addition of any impact modifiers or plasticizers in a secondary compounding step.

Higher amounts of dimer acid or dimer amine (e.g., 45% comonomer content as in Examples 2 and 4) result in low modulus materials. Those same higher dimer content copolymers also demonstrate very high notched Charpy impact strength values, e.g., see Ex. 4 as in Table 4 with an average impact strength of 14.3 KJ/m². Examples with higher dimer acid and/or dimer amine modification provide toughness and flexibility, while also providing excellent chemical and moisture resistance, making them suitable for such applications as for tubing and 3D printing. These compositions show that the addition of the dimer modifiers provides for PA-6,12, for example, copolymers that have moisture uptake performance that is beneficially even less than that of PA12. PA12 is known to be expensive and delicate to manufacture. This satisfies a long-felt need in the industry to have an alternative to PA12 that provides moisture inert materials with stable mechanical properties and dimensional stability that are even better than PA-12 compositions.

In lower amounts of dimer acid or dimer amine (e.g., 20% comonomer content as in Examples 1 or 3) as good or even improved properties are realized as compared with PA6,12 (and at lower manufacturing cost), and advantageously similar tensile properties are maintained as for PA6,12 but with higher toughness as shown in Table 4. Examples with lower dimer acid and/or dimer amine modification provide excellent moisture and chemical resistance comparable to that of PA12 and an overall balance of properties suitable for a wide variety of applications.

### EMBODIMENTS

The following embodiments are contemplated. All combinations of features and embodiments are contemplated.

Embodiment 1: A polyamide composition comprising: from 45 wt % to 95 wt % of polyamide polymer; from 5 wt % to 55 wt % of a modifier comprising a dimer acid or a dimer amine or a combination thereof; wherein the polyamide composition demonstrates: a chemical resistance, as measured by exposure to HCl (10%) for 14 days at 58° C., resulting in a weight loss of less than 3.0 wt %; and a moisture uptake of less than about 2.0 wt % moisture at 95% RH.

Embodiment 2: An embodiment of embodiment 1, wherein the polyamide composition has a methyl/amide ratio ranging from 6:1 to 15:1.

Embodiment 3: An embodiment of embodiment 1 or 2, wherein the polyamide composition has a methyl/amide ratio ranging from 9:1 to 15:1.

Embodiment 4: An embodiment of any of the embodiments of embodiment 1-3, wherein the polyamide composition comprises from 20 wt % to 45 wt % of the modifier comprising a dimer acid or a dimer amine or a combination thereof.

Embodiment 5: An embodiment of any of the embodiments of embodiment 1-4, wherein the polyamide composition demonstrates a moisture uptake of less than about 1.6 wt % moisture at 95% RH.

Embodiment 6: An embodiment of any of the embodiments of embodiment 1-5, wherein the polyamide polymer comprises PA6, PA10, PA11, PA12, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, PA6,C/6,18, or combinations thereof.

Embodiment 7: An embodiment of any of the embodiments of embodiment 1-6, wherein the polyamide polymer comprises PA6,6.

Embodiment 8: An embodiment of any of the embodiments of embodiment 1-7, wherein the polyamide polymer comprises PA6,10.

Embodiment 9: An embodiment of any of the embodiments of embodiment 1-8, wherein the polyamide polymer comprises PA6,12.

Embodiment 10: An embodiment of any of the embodiments of embodiment 1-9, wherein the polyamide polymer comprises PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, or combinations thereof.

Embodiment 11: An embodiment of any of the embodiments of embodiment 1-10, wherein the number average molecular weight of the polyamide polymer ranges from 9,000 g/mol to 60,000 g/mol.

Embodiment 12: An embodiment of any of the embodiments of embodiment 1-11, wherein the number average molecular weight of the polyamide polymer ranges from 20,000 g/mol to 45,000 g/mol.

Embodiment 13: An embodiment of any of the embodiments of embodiment 1-11, wherein the number average molecular weight of the polyamide polymer ranges from 12,000 g/mol to 20,000 g/mol.

Embodiment 14: An embodiment of any of the embodiments of embodiment 1-13, wherein the polyamide polymer has an amine end group content ranging from 10 microeq/g to 110 microeq/g.

Embodiment 15: An embodiment of any of the embodiments of embodiment 1-14, wherein the polyamide polymer has an amine end group content ranging from 35 microeq/g to 80 microeq/g.

Embodiment 16: An embodiment of any of the embodiments of embodiment 1-15, further comprising up to 60 wt % glass fibers.

Embodiment 17: An embodiment of any of the embodiments of embodiment 1-16, further comprising up to 2 wt % lubricant.

Embodiment 18: An embodiment of any of the embodiments of embodiment 1-17, further comprising an additive chosen from a nigrosine dye, a copper containing compound, a plasticizer, or a flame retardant, or combinations thereof.

Embodiment 19: An embodiment of any of the embodiments of embodiment 1-18, further comprising up to 30 wt % mineral additive chosen from calcium carbonate, talc, magnesium hydroxide, kaolin clay, or combinations thereof.

Embodiment 20: An embodiment of any of the embodiments of embodiment 1-19, further comprising an impact modifier chosen from a modified olefin, an unmodified olefin, maleic anhydride-modified olefin, maleic anhydride-unmodified olefin, acrylate, or acrylic, or combinations thereof.

Embodiment 21: An embodiment of any of the embodiments of embodiment 1-20, wherein the polyamide polymer comprises PA6,12, the dimer modifier is dimer amine present in an amount ranging from 15 wt % to 50 wt %, and wherein the polyamide composition demonstrates a tensile elongation of at least 50%.

Embodiment 22: An embodiment of any of the embodiments of embodiment 1-21, wherein the polyamide polymer comprises PA6,12, the dimer modifier is dimer acid present in an amount ranging from 15 wt % to 50 wt %, and wherein the polyamide composition demonstrates a tensile elongation of at least 20%.

Embodiment 23: An embodiment of any of the embodiments of embodiment 1-22, wherein the polyamide polymer comprises PA6,12, the dimer modifier is dimer amine present in an amount ranging from 35 wt % to 55 wt %, and wherein the polyamide composition demonstrates a notched Charpy impact energy loss at 23° C. that is greater than 4.5 kJ/m2.

Embodiment 24: An embodiment of any of the embodiments of embodiment 1-23, wherein the polyamide polymer comprises PA6,12, the dimer modifier is in an amount of about 20 wt %, and wherein the polyamide composition demonstrates a notched Charpy impact energy loss at 23° C. that is greater than 3.5 kJ/m2, a tensile strength greater than 50 MPa, and a tensile modulus greater than 1950 MPa.

Embodiment 25: An embodiment of any of the embodiments of embodiment 1-24, wherein the polyamide composition demonstrates a tensile elongation greater than 30%.

Embodiment 26: An embodiment of any of the embodiments of embodiment 1-25, wherein the polyamide composition demonstrates a notched Charpy impact energy loss at 23° C. that is greater than 3 kJ/m2.

Embodiment 27: An embodiment of any of the embodiments of embodiment 1-26, wherein the polyamide composition demonstrates a tensile modulus greater than 650 MPa.

Embodiment 28: An embodiment of any of the embodiments of embodiment 1-27, the polyamide composition of any previous or subsequent aspect, wherein the polyamide composition demonstrates a tensile elongation greater than 13%.

Embodiment 29: An embodiment of any of the embodiments of embodiment 1-28, wherein the polyamide composition demonstrates an abrasion resistance greater than that of a reference PA6,12 material or a reference PA12 material.

Embodiment 30: An injection molded article comprising the polyamide composition of any of the embodiments of embodiment 1-29.

Embodiment 31: An article comprising the polyamide composition of any of the embodiments of embodiment 1-29, the article being an extruded article, a profile extrusion article, a monofilament, or a fiber.

Embodiment 32: An embodiment of any of the embodiments of embodiment 1-31, wherein the polyamide composition comprises from 45 wt % to 95 wt % of polyamide polymer; from 5 wt % to 55 wt % of a modifier comprising a C₁₈₋₄₄ dimer acid or a C₁₈₋₄₄ dimer amine or a combination thereof; wherein the polyamide composition has a number average molecular weight of the polyamide polymer is less than 30,000 g/mol, a chemical resistance, as measured by exposure to HCl (10%) for 14 days at 58° C., resulting in a weight loss of less than 3.0 wt %; and a moisture uptake of less than about 2.0 wt % moisture at 95% RH.

Embodiment 33: An embodiment of any of the embodiments of embodiment 1-32, wherein the polyamide polymer comprises PA10, PA11, PA12, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, or PA6,C/6,18, or combinations thereof.

Embodiment 34: An embodiment of any of the embodiments of embodiment 1-33, wherein the polyamide polymer comprises PA6,10, PA6,12, or combinations thereof.

Embodiment 35: An embodiment of any of the embodiments of embodiment 1-34, wherein the modifier is a single modifier comprising either a single dimer acid or a single dimer amine.

Embodiment 36: An embodiment of any of the embodiments of embodiment 1-35, wherein the polyamide composition has a melting temperature from 165° C. to 270° C.

Embodiment 37: An embodiment of any of the embodiments of embodiment 1-36, wherein the polyamide composition has a melting temperature from 170° C. to 215° C.

Embodiment 38: An embodiment of any of the embodiments of embodiment 1-37, wherein the polyamide composition comprises from 20 wt % to 45 wt % of the modifier comprising a dimer acid or a dimer amine or a combination thereof.

Embodiment 39: An embodiment of any of the embodiments of embodiment 1-38, wherein the number average molecular weight of the polyamide polymer ranges from 10,000 g/mol to 25,000 g/mol.

Embodiment 40: An embodiment of any of the embodiments of embodiment 1-39, wherein the polyamide polymer has an amine end group content ranging from 10 microeq/g to 110 microeq/g, or wherein the polyamide polymer has an amine end group content ranging from 35 microeq/g to 80 microeq/g.

Embodiment 41: An embodiment of any of the embodiments of embodiment 1-40, wherein the polyamide composition comprises glass fibers present in an amount greater than 5 wt %.

Embodiment 42: An embodiment of any of the embodiments of embodiment 1-41, wherein the polyamide composition comprises a lubricant present in an amount greater than 0.3 wt %.

Embodiment 43: An embodiment of any of the embodiments of embodiment 1-42, wherein the polyamide composition comprises an impact modifier present in an amount greater than 3 wt %.

Embodiment 44: An embodiment of any of the embodiments of embodiment 1-43, wherein the polyamide polymer comprises PA6,12, and the dimer modifier is present in an amount ranging from 15 wt % to 50 wt %, wherein one of either: the dimer modifier is a single dimer amine and the polyamide composition demonstrates a tensile elongation of at least 50%; and, the dimer modifier is a single dimer acid and the polyamide composition demonstrates a tensile elongation of at least 20%.

Embodiment 45: An embodiment of any of the embodiments of embodiment 1-44, wherein the polyamide polymer comprises PA6,12, the dimer modifier is a single dimer amine present in an amount ranging from 35 wt % to 55 wt %, and wherein the polyamide composition demonstrates a notched Charpy impact energy loss at 23° C. that is greater than 4.5 kJ/m²

Embodiment 46: An embodiment of any of the embodiments of embodiment 1-45, wherein the polyamide polymer comprises PA6,12, the dimer modifier is in an amount of about 20 wt %, and wherein the polyamide composition demonstrates a notched Charpy impact energy loss at 23° C. that is greater than 3.5 kJ/m², a tensile strength greater than 50 MPa, and a tensile modulus greater than 1950 MPa.

Embodiment 47: A molded article of any embodiment 1-46, wherein the article comprises a polyamide composition comprising from 45 wt % to 95 wt % of polyamide polymer and from 5 wt % to 55 wt % of a modifier comprising a C₁₈₋₄₄ dimer acid or a C₁₈₋₄₄ dimer amine or a combination thereof, wherein the molded article composition has a number average molecular weight of the polyamide polymer is less than 30,000 g/mol; a chemical resistance, as measured by exposure to HCl (10%) for 14 days at 58° C., resulting in a weight loss of less than 3.0 wt %; and a moisture uptake of less than about 2.0 wt % moisture at 95% RH.

Embodiment 48: A process of any of the embodiments of embodiment 1-47, wherein the process comprises preparing a high solids monomer solution in aqueous salts, wherein the solids content is greater than 80%; evaporating the high solids monomer solution in an evaporator, wherein starting concentrations are greater than 60 wt %; and, adding a modifier comprising a C₁₈₋₄₄ dimer acid or a C₁₈₋₄₄ dimer amine or a combination thereof to form a single mixture, wherein the modifier bypasses the evaporator; wherein the polyamide composition demonstrates: a chemical resistance, as measured by exposure to HCl (10%) for 14 days at 58° C., resulting in a weight loss of less than 3.0 wt %; and a moisture uptake of less than about 2.0 wt % moisture at 95% RH.

Embodiment 49: An embodiment of any of the embodiments of embodiment 1-48, wherein the polyamide polymer comprises PA6,10, PA6,12, or combinations thereof.

Embodiment 50: An embodiment of any of the embodiments of embodiment 1-50, wherein the modifier is a single modifier comprising either a single C₁₈₋₄₄ dimer acid or a single C₁₈₋₄₄ dimer amine.

While the disclosure has been described in detail, modifications within the spirit and scope of the disclosure will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the disclosure and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the disclosure.

We claim:

1. A polyamide composition comprising:
from 45 wt % to 95 wt % of polyamide polymer;
from 5 wt % to 55 wt % of a modifier comprising a C₁₈₋₄₄ dimer acid or a C₁₈₋₄₄ dimer amine or a combination thereof;
wherein the polyamide composition has:
a number average molecular weight of the polyamide polymer is less than 30,000 g/mol;
a chemical resistance, as measured by exposure to HCl (10%) for 14 days at 58° C., resulting in a weight loss of less than 3.0 wt %; and
a moisture uptake of less than about 2.0 wt % moisture at 95% RH.

2. The polyamide composition of claim 1, wherein the polyamide polymer comprises PA10, PA11, PA12, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA6T/66, PA6T/6I, PA6T/6I/66, PA6T/DT, PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, or PA6,C/6,18, or combinations thereof.

3. The polyamide composition of claim 2, wherein the polyamide polymer comprises PA6,10, PA6,12, or combinations thereof.

4. The polyamide composition of claim 1, wherein composition comprises a single modifier comprising either a single dimer acid or a single dimer amine.

5. The polyamide composition of claim 1, wherein the polyamide composition has a melting temperature from 165° C. to 270° C.

6. The polyamide composition of claim 5, wherein the polyamide composition has a melting temperature from 170° C. to 215° C.

7. The polyamide composition of claim 1, wherein the polyamide composition comprises from 20 wt % to 45 wt % of the modifier.

8. The polyamide composition of claim 1, wherein the polyamide composition has a methyl/amide ratio ranging from 6:1 to 15:1.

9. The polyamide composition of claim 1, wherein the number average molecular weight of the polyamide polymer ranges from 10,000 g/mol to 25,000 g/mol.

10. The polyamide composition of claim 1, wherein the polyamide polymer has an amine end group content ranging from 10 microeq/g to 110 microeq/g.

11. The polyamide composition of claim 1, further comprising glass fibers present in an amount greater than 5 wt %.

12. The polyamide composition of claim 1, further comprising a lubricant present in an amount greater than 0.3 wt %.

13. The polyamide composition of claim 1, further comprising an impact modifier present in an amount greater than 3 wt %.

14. The polyamide composition of claim 1, wherein the polyamide polymer comprises PA6,12, and the dimer modifier is present in an amount ranging from 15 wt % to 50 wt %, wherein one of either:
the dimer modifier is a single dimer amine and the polyamide composition demonstrates a tensile elongation of at least 50%; and,
the dimer modifier is a single dimer acid and the polyamide composition demonstrates a tensile elongation of at least 20%.

15. The polyamide composition of claim 1, wherein the polyamide polymer comprises PA6,12, the dimer modifier is a single dimer amine present in an amount ranging from 35 wt % to 55 wt %, and wherein the polyamide composition demonstrates a notched Charpy impact energy loss at 23° C. that is greater than 4.5 kJ/m².

16. The polyamide composition of claim 1, wherein the polyamide polymer comprises PA6,12, the dimer modifier is in an amount of about 20 wt %, and wherein the polyamide composition demonstrates a notched Charpy impact energy loss at 23° C. that is greater than 3.5 kJ/m², a tensile strength greater than 50 MPa, and a tensile modulus greater than 1950 MPa.

17. A molded article comprising:
a polyamide composition comprising:
from 45 wt % to 95 wt % of polyamide polymer;
from 5 wt % to 55 wt % of a modifier comprising a C₁₈₋₄₄ dimer acid or a C₁₈₋₄₄ dimer amine or a combination thereof;
wherein the molded article composition has:
a number average molecular weight of the polyamide polymer is less than 30,000 g/mol;
a chemical resistance, as measured by exposure to HCl (10%) for 14 days at 58° C., resulting in a weight loss of less than 3.0 wt %; and
a moisture uptake of less than about 2.0 wt % moisture at 95% RH.

18. A process for preparing a polyamide composition comprising:
preparing a high solids monomer solution in aqueous salts, wherein the solids content is greater than 80%;
evaporating the high solids monomer solution in an evaporator, wherein starting concentrations are greater than 60 wt %; and,
adding a modifier comprising a C₁₈₋₄₄ dimer acid or a C₁₈₋₄₄ dimer amine or a combination thereof to form a single mixture, wherein the modifier bypasses the evaporator;
wherein the polyamide composition demonstrates:
a number average molecular weight of the polyamide polymer is less than 30,000 g/mol;
a chemical resistance, as measured by exposure to HCl (10%) for 14 days at 58° C., resulting in a weight loss of less than 3.0 wt %; and
a moisture uptake of less than about 2.0 wt % moisture at 95% RH.

19. The process of claim 18, wherein the polyamide polymer comprises PA6,10, PA6,12, or combinations thereof.

20. The process of claim 18, wherein the modifier is a single modifier comprising either a single C₁₈₋₄₄ dimer acid or a single C₁₈₋₄₄ dimer amine.
